(19) United States
(12) Patent Application Publication
(10) Pub. No.: US 2020/0365039 A1
(43) Pub. Date: Nov. 19, 2020

(54) INFORMATION PROCESSING APPARATUS

(71) Applicant: NTT DOCOMO, INC., Tokyo (JP)

(72) Inventors: Takefumi Yamada, Tokyo (JP); Ken Koumoto, Tokyo (JP); Youhei Oono, Tokyo (JP); Hidetoshi Ebara, Tokyo (JP); Yuichiro Segawa, Tokyo (JP)

(73) Assignee: NTT DOCOMO, INC., Tokyo (JP)

(21) Appl. No.: 16/761,382

(22) PCT Filed: Oct. 30, 2018
(86) PCT No.: PCT/JP2018/040371

§ 371 Date: May 4, 2020

(30) Foreign Application Priority Data
Nov. 15, 2017 (JP) 2017-220065

(51) Int. Cl. G08G 5/00; G08G 5/04; B64C 39/02

(52) U.S. Cl. CPC G08G 5/0026; B64C 39/02; G08G 5/04

(57) ABSTRACT

Flight airspace allocation unit allocates a good communication airspace in which the quality of communication with base station is no lower than the predetermined level to all drones, and allocates a bad communication airspace in which the communication quality is lower than the predetermined level to drone that satisfies an allocation condition. Flight airspace allocation unit uses, as the allocation condition, a condition that is to be satisfied when the capability of drone is no lower than a predetermined standard. For example, if drone has flight has an avoidance function that is the function of avoiding an obstacle in order to avoid a collision, flight airspace allocation unit determines that the capability of that drone is no lower than the predetermined standard.

### TECHNICAL FIELD

The present invention relates to a technique for allocating flight airspace to an aircraft.

### BACKGROUND ART

Techniques for allocating flight airspace to an aircraft are known. For example, JP 2017-62724A discloses a technique that provides an air route along which an unmanned aircraft flies, the air route being located in a space higher than the tops of electrical wire poles with respect to the vertical direction and having a cross-sectional shape defined by a width determined on the basis of the shapes of the electrical wire poles.

### SUMMARY OF INVENTION

When a drone flies, it is envisaged that the drone communicates with a communication facility (such as a base station) as necessary, the communication facility being connected to a center that makes flight instructions. However, communication quality may be worse in some airspace than in other airspace (for example, communication is unavailable, or the communication speed is very low). However, in order to effectively use limited airspace, it may be preferable to also use airspace in which communication quality is bad.

Accordingly, an object of the present invention is, even if airspace that can be allocated to an aircraft includes a portion in which communication quality is worse than in other airspace, to effectively use the entire airspace.

In order to fulfill the above-described object, the present invention provided an information processing apparatus that includes: an allocation unit that allocates flight airspace to aircrafts that fly while communicating with a communication facility, the allocation unit allocating a first airspace, in which the quality of communication with the communication facility is no lower than a predetermined level, to all aircrafts, and allocating a second airspace, in which the quality of communication is lower than the predetermined level, to an aircraft that satisfies a predetermined condition.

The condition may be satisfied when a capability of the aircraft is no lower than a predetermined standard.

Furthermore, the allocation unit may determine that the capability of the aircraft is no lower than the standard when a difference between a flight plan and a flight result of the aircraft is less than a threshold.

Furthermore, the allocation unit may determine that the capability of the aircraft is no lower than the standard when the aircraft has a function of avoiding a collision with an obstacle.

Furthermore, the allocation unit may determine that the capability of the aircraft is no lower than the standard when the aircraft has a function of setting a path to a destination.

Furthermore, the allocation unit may determine that the capability of the aircraft is no lower than the standard when the aircraft has a function of carrying out a formation flight with another aircraft.

The allocation unit may set an upper limit of a flight distance in the second airspace in flight airspace that is to be allocated to the aircraft that satisfies the condition, to a distance that corresponds to a level of the capability of the aircraft.

The allocation unit may allocate the flight airspace based on a flight schedule of the aircraft, and determine that the condition is satisfied when a difficulty level of the flight schedule is lower than a predetermined difficulty level.

Furthermore, when the weather in the second airspace includes a meteorological condition that hinders the aircraft from flying through the flight airspace allocated thereto, the allocation unit may use, as the predetermined condition, a condition that becomes less likely to be satisfied as the degree of hindrance caused by the meteorological condition increases.

The information processing apparatus may further include a detection unit that detects a change in the first airspace, and allocation unit may allocate the first airspace that reflects the detected change, to the aircraft that does not satisfy the condition.

### ADVANTAGEOUS EFFECTS OF THE INVENTION

According to the present invention, even if airspace that can be allocated to an aircraft includes a portion in which communication quality is worse than in other airspace, it is possible to use the entire airspace effectively.

### BRIEF DESCRIPTION OF DRAWINGS

FIG. 1 is a diagram illustrating the overall configuration of a drone operation management system according to an embodiment.

FIG. 2 is a diagram illustrating the hardware configuration of a server apparatus and the like.

FIG. 3 is a diagram illustrating the hardware configuration of a drone.

FIG. 4 is a diagram illustrating a functional configuration realized by the drone operation management system.

FIG. 5 is a diagram illustrating an example of generated flight schedule information.

FIG. 6 is a diagram illustrating an example of airspace information.

FIG. 7 is a diagram illustrating an example of tentatively-determined flight airspace.

FIG. 8 is a diagram illustrating an example of tentatively-determined permitted flight periods.

FIG. 9 is a diagram illustrating an example of tentatively-determined flight airspace.

FIG. 10 is a diagram illustrating an example of tentative determination information.

FIG. 11 is a diagram illustrating an example of generated flight control information.

FIG. 12 is a diagram illustrating an example of operation sequences carried out by apparatuses in an allocation process.

FIG. 13 is a diagram illustrating a functional configuration realized by a server apparatus according to a variation.

FIG. 14 is a diagram illustrating a functional configuration realized by a drone according to a variation.

FIG. 15 is a diagram illustrating a functional configuration realized by a drone according to a variation.

FIG. 16 is a diagram illustrating an example of a flight distance table.

FIG. 17 is a diagram illustrating an example of a difficulty level table.

FIG. 18 is a diagram illustrating an example of a difficulty level table using other factors.

FIG. 19 is a diagram illustrating a functional configuration realized by a server apparatus according to a variation.

FIG. 20 is a diagram illustrating an example of an allocation condition table.

FIG. 21 is a diagram illustrating a functional configuration realized by a server apparatus according to a variation.

### DETAILED DESCRIPTION

### 1. Embodiment

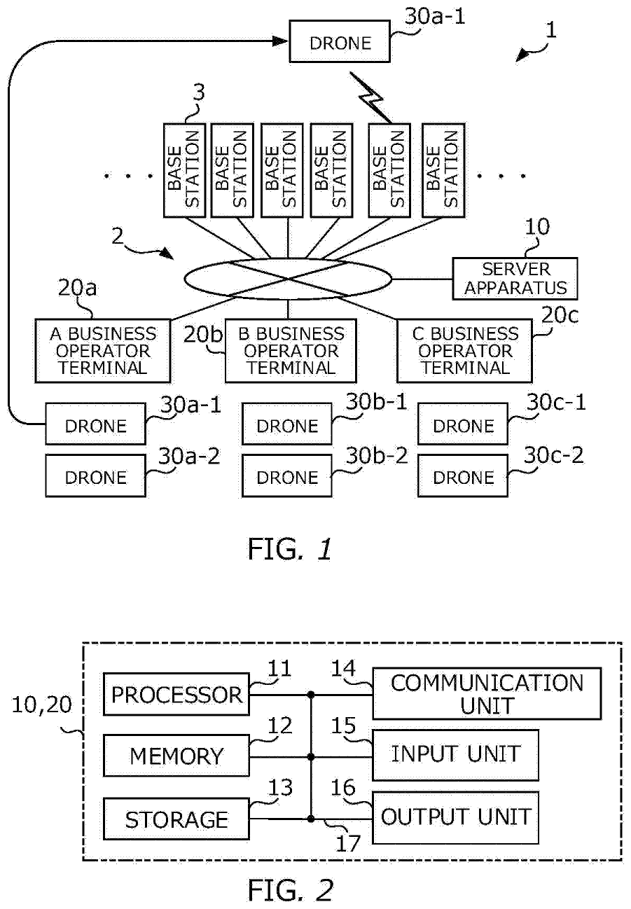

FIG. 1 is a diagram illustrating the overall configuration of drone operation management system 1 according to an embodiment. Drone operation management system 1 is a system that manages operations of a drone. “Operation management” refers to managing flight of an aircraft such as a drone on the basis of a flight plan. In, for example, an environment in which multiple drones are flying, drone operation management system 1 supports the safe and smooth flight of the drones by allocating flight airspace to the drones and making instructions pertaining to the flight to the drones (flight instructions).

A “drone” is an aircraft that is capable of flying in accordance with a flight plan and that is typically unmanned, and is an example of an “aircraft” according to the present invention. Drones are mainly used by companies operating transport, filming, and surveillance businesses, for example. Although the present embodiment describes unmanned drones as the subject of the operation management, manned drones also exist, and manned drones may therefore also be subject to the operation management. Regardless of whether or not drone operation management system 1 handles manned aircraft, a scope of management for carrying out control in which the flight airspace of manned craft such as airplanes is ascertained and flight instructions or the like are issued may be included in the operation management carried out by drone operation management system 1.

Drone operation management system 1 includes network 2, server apparatus 10, A business operator terminal 20a, B business operator terminal 20b, C business operator terminal 20c (called “business operator terminals 20” when there is no need to distinguish between them), drones 30a-1 and 30a-2 of A business operator, drones 30b-1 and 30b-2 of B business operator, and drones 30c-1 and 30c-2 of C business operator (called “drones 30” when there is no need to distinguish between them).

Network 2 is a communication system including a mobile communication network, the Internet, and the like and having a plurality of base stations 3, and relays the exchange of data between devices accessing that system. Each base station 3 is a facility provided with an antenna that transmits and receives radio waves for mobile communication, and is an example of a “communication facility” according to the present invention. Network 2 is accessed by server apparatus 10 and business operator terminals 20 through wired communication (or wireless communication). Drones 30 that are flying wirelessly communicate with base stations 3, and access network 2 via base stations 3 that are communication partners.

Business operator terminals 20 are terminals used by, for example, persons in charge of the operation and management of drones 30 (operation managers) in the respective businesses. Business operator terminals 20 generate flight schedules specifying overviews of flights planned for drones 30 through operations made by the operation managers, and transmit the generated flight schedules to server apparatus 10, for example. Server apparatus 10 is an information processing apparatus that carries out processing pertaining to the allocation of flight airspace to drones 30. Server apparatus 10 allocates flight airspace to each drone 30 on the basis of the received flight schedule.

To be more specific, “allocating flight airspace” means allocating both flight airspace and a permitted flight period. Flight airspace is information indicating a space through which drone 30 is to pass when flying from a departure point to a destination, and the permitted flight period is information indicating a period for which flight is permitted in the allocated flight airspace. Server apparatus 10 creates allocation information indicating the allocated flight airspace and the permitted flight period, and transmits the created allocation information to business operator terminal 20.

Business operator terminal 20 generates flight control information, which is an information set by which drone 30 controls its own flight, on the basis of the received allocation information, and transmits the generated flight control information to the target drone 30. Although the information used by drone 30 to control the flight differs depending on the specifications of the program that controls drone 30, flight altitude, flight direction, flight speed, spatial coordinates of the point of arrival, and the like are used, for example.

Drone 30 is an aircraft that flies autonomously or according to a flight plan (a flight plan according to the allocated flight airspace and the permitted flight period), and in the present embodiment, is a rotary-wing aircraft that includes one or more rotors and flies by rotating those rotors. All drones 30 include a coordinate measurement function for measuring the position and altitude of that drone 30 (i.e., spatial coordinates in a three-dimensional space) and a time measurement function for measuring time, and can fly within the flight airspace and permitted flight period indicated by the allocation information by controlling the flight speed and flight direction while measuring the spatial coordinates and the time.

Also, drone 30 flies while notifying server apparatus 10 and business operator terminal 20 of the flight status via base stations 3. Server apparatus 10 makes a flight instruction to drone 30 if necessary, on the basis of the notified flight status (for example, when there is a significant delay due to a failure or the like). Business operator terminal 20 may also make a flight instruction to drone 30 through an operation made by the operation manager (via server apparatus 10 in the present embodiment). In this manner, drone 30 can manage unexpected situations when flying by communicating with base stations 3 while flying.

FIG. 2 is a diagram illustrating the hardware configuration of server apparatus 10 and the like. Server apparatus 10 and the like (server apparatus 10 and business operator terminal 20) are both computers that include the following apparatuses, namely processor 11, memory 12, storage 13, communication unit 14, input unit 15, output unit 16, and bus 17. The term “apparatus” used here can be replaced with “circuit”, “device”, “unit”, or the like. One or more of each apparatus may be included, and some apparatuses may be omitted.

Processor 11 controls the computer as a whole by running an operating system, for example. Processor 11 may be constituted by a central processing unit (CPU) including an interface with peripheral apparatuses, a control apparatus, a computation apparatus, registers, and the like. Additionally, processor 11 reads out programs (program code), software modules, data, and the like from storage 13 and/or communication unit 14 into memory 12, and then executes various types of processes in accordance therewith.

There may be one, or two or more, processors 11 that execute the various types of processes, and two or more processors 11 may execute various types of processes simultaneously or sequentially. Processor 11 may be provided as one or more chips. The programs may be transmitted from a network over an electrical communication line.

Memory 12 is a computer-readable recording medium, and may be constituted by at least one of ROM (Read Only Memory), EPROM (Erasable Programmable ROM), EEPROM (Electrically Erasable Programmable ROM), RAM (Random Access Memory), and so on, for example. Memory 12 may be called a “register”, “cache”, “main memory” (a main storage apparatus), or the like. Memory 12 can store the aforementioned programs (program code), software modules, data, and the like.

Storage 13 is a computer-readable recording medium, and may be constituted by at least one of an optical disk such as a CD-ROM (Compact Disc ROM), a hard disk drive, a flexible disk, a magneto-optical disk (e.g., a compact disk, a digital versatile disk, or a Blu-ray (registered trademark) disk), a smartcard, flash memory (e.g., a card, a stick, or a key drive), a Floppy (registered trademark) disk, a magnetic strip, and the like.

Storage 13 may be called an auxiliary storage apparatus. The aforementioned storage medium may be a database, a server, or another appropriate medium including memory 12 and/or storage 13, for example. Communication unit 14 is hardware for communicating between computers over a wired and/or wireless network (a transmission/reception device), and is also called a network device, a network controller, a network card, a communication module, and the like, for example.

Input unit 15 is an input device that accepts inputs from the exterior (e.g., a keyboard, a mouse, a microphone, a switch, a button, a sensor, or the like). Output unit 16 is an output device that makes outputs to the exterior (e.g., a display, a speaker, or the like). Note that input unit 15 and output unit 16 may be configured integrally (e.g., a touchscreen). The apparatuses such as processor 11 and memory 12 can access each other over bus 17, which is used for communicating information. Bus 17 may be constituted by a single bus, or may be constituted by buses that differ among the apparatuses.

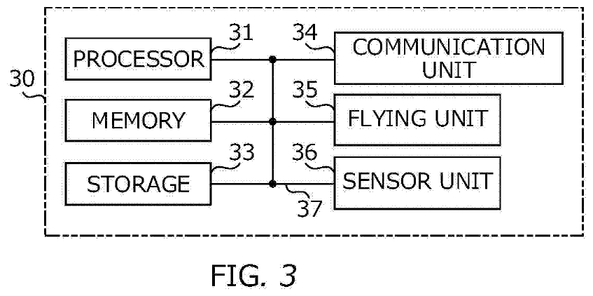

FIG. 3 illustrates the hardware configuration of drone 30. Drone 30 is a computer including the following apparatuses, namely processor 31, memory 32, storage 33, communication unit 34, flying unit 35, sensor unit 36, and bus 37. The term “apparatus” used here can be replaced with “circuit”, “device”, “unit”, or the like. One or more of each apparatus may be included, and some apparatuses may be omitted.

Processor 31, memory 32, storage 33, and bus 37 are the same as the hardware of the same names illustrated in FIG. 2. Communication unit 34 can not only communicate wirelessly with the network 2, but can also implement wireless communication between drones 30. Flying unit 35 includes the aforementioned rotors and driving means such as a motor for rotating the rotors, and is an apparatus for causing the host device (drone 30) to fly. Flying unit 35 can move the host device in all directions, stop the host device (hovering), and the like while in the air.

Sensor unit 36 is an apparatus including a sensor group that obtains information necessary for flight control. Sensor unit 36 includes a position sensor that measures the position (latitude and longitude) of the host device, a direction sensor that measures the direction the host device is facing (a forward direction is defined for drone 30, and the forward direction is the direction the host device is facing), and an altitude sensor that measures the altitude of the host device. In the present embodiment, sensor units 36 of drones 30a-1, 30b-1, and 30c-1 include object recognition sensors that emit infrared light, millimeter waves, or the like and measure the distance to an object and the direction of the object on the basis of a time until reflected waves are received and the direction from which the reflected waves are received. Note that the object recognition sensor may be a sensor that includes an image sensor, a lens, and the like, and that recognizes an object by analyzing a captured image of the object.

On the other hand, sensor units 36 of drones 30a-2, 30b-2, and 30c-2 do not include object recognition sensors. The object recognition sensor is used for an avoidance function, in which drone 30 measures the distance and direction of an obstacle such as another drone 30, and when the obstacle has come within a predetermined distance, drone 30 changes the flight direction to a direction for avoiding the obstacle in order to avoid a collision. In the present embodiment, drones 30a-1, 30b-1, and 30c-1 have the avoidance function, and drones 30a-2, 30b-2, and 30c-2 do not have the avoidance function.

Note that server apparatus 10, drones 30, and so on may be configured including hardware such as microprocessors, DSPs (Digital Signal Processors), ASICs (Application Specific Integrated Circuits), PLDs (Programmable Logic Devices), FPGA (Field Programmable Gate Arrays), and the like, and some or all of the function blocks may be realized by that hardware. For example, processor 11 may be provided as at least one of these types of hardware.

Server apparatus 10, business operator terminals 20, and drones 30 included in drone operation management system 1 store programs provided by the system, and implement the following group of functions by the processors included in the devices executing programs and controlling the various units.

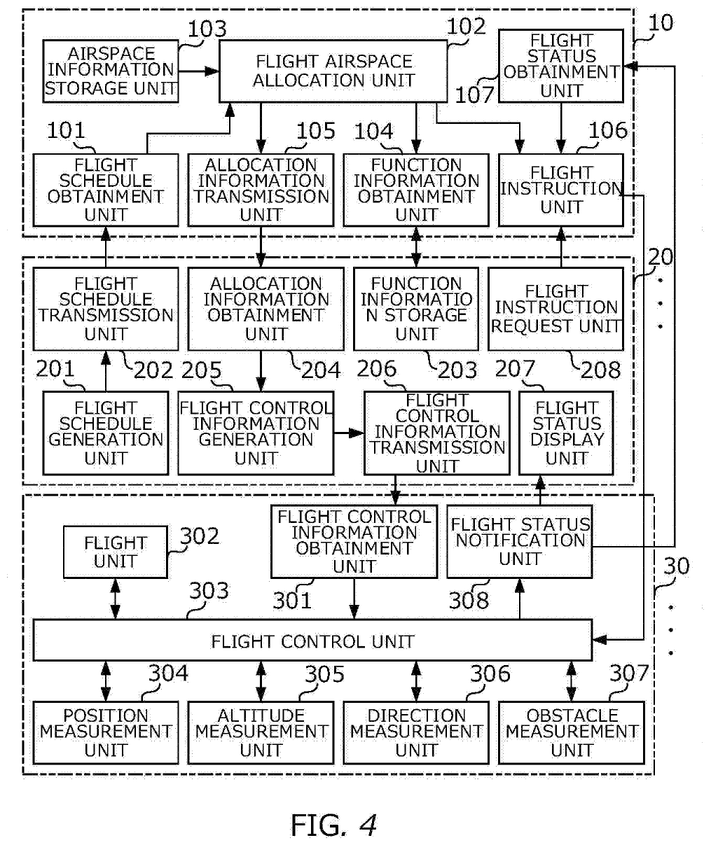

FIG. 4 illustrates a functional configuration realized by drone operation management system 1. Although only one each of business operator terminals 20 and drones 30 are illustrated in FIG. 4, the multiple business operator terminals 20 and multiple drones 30 all have the same functional configuration.

Server apparatus 10 includes flight schedule obtainment unit 101, flight airspace allocation unit 102, airspace information storage unit 103, function information obtainment unit 104, allocation information transmission unit 105, flight instruction unit 106, and flight status obtainment unit 107. Business operator terminal 20 includes flight schedule generation unit 201, flight schedule transmission unit 202, function information storage unit 203, allocation information obtainment unit 204, flight control information generation unit 205, flight control information transmission unit 206, flight status display unit 207, and flight instruction request unit 208.

Drone 30 includes flight control information obtainment unit 301, flight unit 302, flight control unit 303, position measurement unit 304, altitude measurement unit 305, direction measurement unit 306, obstacle measurement unit 307, and flight status notification unit 308. Note that drones 30a-2, 30b-2, and 30c-2 in which sensor units 36 do not include object recognition sensors as described above do not include obstacle measurement unit 307.

Flight schedule generation unit 201 of business operator terminal 20 generates the flight schedule information, which indicates the flight schedule of drone 30. Flight schedule generation unit 201 generates the flight schedule information on the basis of input information, upon the aforementioned operation manager inputting, to business operator terminal 20, a drone ID (identification) identifying drone 30 for which the flight schedule is to be input, the names of the departure point, transit point, and destination, estimated departure time, and estimated arrival time, for example. Note that the flight schedule information is merely information indicating a flight schedule desired or requested by the business operator, and does not indicate a finalized flight plan.

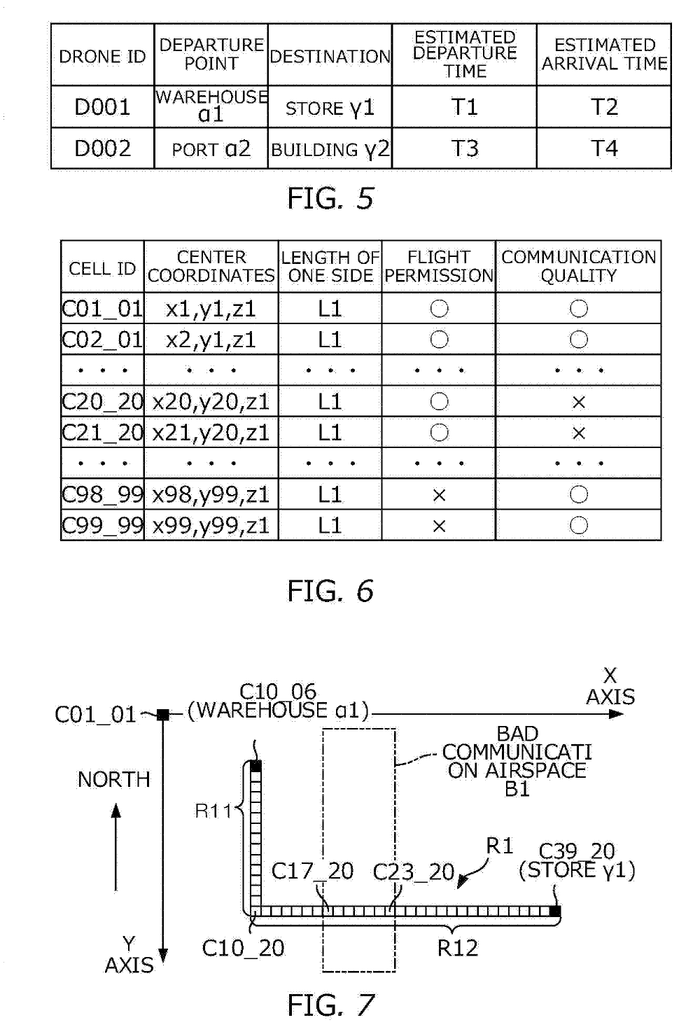

FIG. 5 is a diagram illustrating an example of the generated flight schedule information. In the example in FIG. 5, “warehouse α1”, “store γ1”, “T1”, and “T2”, which are the departure point, destination, estimated departure time, and estimated arrival time, respectively, are associated with a drone ID of “D001”, which identifies drone 30a-1 illustrated in FIG. 1. Also, “port α2”, “building γ2”, “T3”, and “T4”, which are the departure point, destination, estimated departure time, and estimated arrival time, respectively, are associated with a drone ID of “D002”, which identifies drone 30b-2.

It is assumed that times such as “T1” actually express times in one-minute units, such as “9 hours 00 minutes”. Note, however, that the time may be expressed at a finer level (e.g., in units of seconds), or at a broader level (e.g., in units of five minutes). Furthermore, although the date of the flight schedule may also be input, the present embodiment assumes that the operation manager inputs the flight schedule for that day on the morning of that day (i.e., that the date is unnecessary), to simplify the descriptions.

The flight schedule information of drone 30a-1 is generated by flight schedule generation unit 201 of A business operator terminal 20a. The flight schedule information of drone 30b-2 is generated by flight schedule generation unit 201 of B business operator terminal 20b, and the flight schedule information of drone 30c-1 is generated by flight schedule generation unit 201 of C business operator terminal 20c. Flight schedule generation unit 201 supplies the generated flight schedule information to flight schedule transmission unit 202.

Flight schedule transmission unit 202 transmits the supplied flight schedule information to server apparatus 10. By transmitting the flight schedule information of drone 30, a request to allocate flight airspace (specifically, flight airspace and a permitted flight period) to that drone 30 is made. Flight schedule obtainment unit 101 of server apparatus 10 obtains the flight schedule information transmitted from each business operator terminal 20. Flight schedule obtainment unit 101 supplies the obtained flight schedule information to flight airspace allocation unit 102.

On the basis of the supplied flight schedule information for drone 30, flight airspace allocation unit 102 allocates the flight airspace requested for that drones 30, i.e., the flight airspace in which that drone 30 is to fly (a space through which drone 30 is to travel when flying from the departure point to the destination) and the permitted flight period (the period in which drone 30 is permitted to fly in that flight airspace) to that drone 30. Flight airspace allocation unit 102 is an example of an “allocation unit” according to the present invention. Details of the allocation method will be described below.

In drone operation management system 1, flyable airspace through which drones 30 can fly is determined in advance, in the same manner as a network of roads. The flyable airspace is of course airspace for which permission necessary for flight has been obtained, and may sometimes contain airspace for which permission is not needed. In the present embodiment, the flyable airspace is expressed as cubic spaces laid out without gaps therebetween (called “cells” hereinafter), and each cell is assigned a cell ID for identifying that cell.

Airspace information storage unit 103 stores airspace information regarding each airspace included in the flyable airspace.

FIG. 6 illustrates an example of airspace information. In the example in FIG. 6, airspace information storage unit 103 stores airspace information in which the cell ID indicating airspace, center coordinates of the cell, the length of one side of the cubic cell, whether or not flight is permitted, and the quality of communication with base stations 3 in airspace are associated with each other. In this airspace information, cell IDs “C01_01”, “C02_01”, and so on up to “C99_99” are associated with center coordinates “x1,y1,z1”, “x2,y1,z1”, and so on up to “x99,y99,z99”, respectively.

In the present embodiment, to simplify the descriptions, the cells have a constant altitude, and the xy coordinates of each cell are indicated as being associated with the cell ID (e.g., the cell having xy coordinates of (x10,y15) is given a cell ID of C10_15). In the example in FIG. 6, the lengths of the sides of each cell are all “L1”. Also, in airspace information, for whether or not flight is permitted, a circle indicates that the cell is included in flyable airspace, while an x indicates that the cell is included in non-flyable airspace. For example, airspace above an important facility and a place through which people pass is defined as non-flyable airspace.

Communication quality is quality evaluated using indicators indicating whether or not the transmitted data can be reliably received, the time required for data to be received, and so on. Specifically, communication quality is evaluated using, as indicators, values indicating the reception strength of radio waves, the communication speed, the transmission speed, the packet loss rate, and the delay amount, or temporal fluctuations in them, for example. An uplink and a down link can be targets of evaluation of communication quality.

An uplink is a communication path via which data is transmitted from drone 30 to base station 3, and a downlink is a communication path via which data is transmitted from base station 3 to drone 30. There are three methods for evaluating communication quality, namely, a method through which only an uplink is evaluated, a method through which only a downlink is evaluated, and a method through which both of them are evaluated, and the present embodiment describes a case where both the uplink and the downlink are evaluated. In drone operation management system 1, for example, a system manager flies a drone in flyable airspaces in advance, and measures indicators (such as a reception strength) indicating the quality of communication with base station 3 in each airspace (each cell) for both the uplink and the downlink.

If the aforementioned indicators of both the uplink and the downlink are within the range of values that can be obtained when the communication quality is good, the system manager determines that the communication quality in the airspace for which the measurement has been performed is no lower than a certain level (a communication quality indicated by a circle). If the indicators are not within the range, the system manager determines that the communication quality in the airspace is lower than the predetermined level (a communication quality indicated by x). In the example in FIG. 6, the communication quality of airspaces with cell IDs of C20_20 and C21_20 are determined as “x”.

The system manager creates airspace information in which the results of determination of communication quality and the cell IDs of the target airspaces are associated with each other, and stores the airspace information in airspace information storage unit 103. As shown in FIG. 6, the quality of communication with base station 3 in flyable airspace is not uniform, and in some airspaces, communication quality is so low that data transmission or reception is unavailable. Flight airspace allocation unit 102 allocates flight airspace in view of the quality of communication with base station 3 in each airspace.

Specifically, flight airspace allocation unit 102 allocates a good communication airspace in which the quality of communication with base station 3 is no lower than the predetermined level (an airspace in which the communication quality indicated by airspace information is that indicated by a circle) to all drones 30, and a bad communication airspace in which the communication quality is lower than the predetermined level (an airspace in which the communication quality indicated by airspace information is that indicated by x) to drones 30 that satisfy the allocation conditions described below. The good communication airspace is an example of a “first airspace” according to the present invention, and the bad communication airspace is an example of a “second airspace” according to the present invention. The allocation conditions are examples of “predetermined conditions” according to the present invention.

In the present embodiment, flight airspace allocation unit 102 uses, as the allocation conditions, conditions that are to be satisfied when the capabilities of drone 30 are no lower than a predetermined standard. For example, if drone 30 has an avoidance function that is the function of avoiding an obstacle in order to avoid a collision, flight airspace allocation unit 102 determines that the capabilities of that drone 30 are no lower than the predetermined standard. In order to perform this determination, flight airspace allocation unit 102 requests function information obtainment unit 104 to send function information indicating the function of drones 30 to which airspace is to be allocated.

Upon being requested by flight airspace allocation unit 102 to send function information regarding drone 30, function information obtainment unit 104 requests business operator terminal 20 that has transmitted the flight plan of that drone 30, to send function information regarding that drone 30. Function information storage unit 203 of business operator terminal 20 stores function information regarding drones 30 that are operated and managed using the terminal. This function information has been created and stored in function information storage unit 203 by the operation manager of drone 30, for example.

In the present embodiment, function information storage unit 203 stores function information that indicates whether or not drone 30 has the avoidance function. If function information storage unit 203 stores function information regarding drone 30 requested by function information obtainment unit 104, function information storage unit 203 transmits the function information to server apparatus 10. Function information obtainment unit 104 obtains the function information transmitted thereto, and supplies the function information to flight airspace allocation unit 102.

If the supplied function information indicates that drone 30 has the avoidance function, i.e., if drone 30 to which airspace is to be allocated has the avoidance function, flight airspace allocation unit 102 determines that the capabilities of that drone 30 are no lower than the predetermined standard, and determines that drone 30 as a target (allocation target) to which a bad communication airspace is to be allocated as flight airspace. The allocation target mentioned here does not refer to a target to which a bad communication airspace is invariably allocated, and refers to a target to which a bad communication airspace is allocated when a flight pass that is to be allocated includes a bad communication airspace, and that does not detour the bad communication airspace.

In the present embodiment, flight airspace allocation unit 102 allocates not only a good communication airspace, but also a bad communication airspace, to drones 30a-1, 30b-1, and 30c-1 that have the avoidance function as described above. Flight airspace allocation unit 102 does not allocate a bad communication airspace, but allocates a good communication airspace, to drones 30a-2, 30b-2, and 30c-2 that do not have the avoidance function.

Flight airspace allocation unit 102 first tentatively determines the flight airspaces to be allocated to drones 30. Specifically, flight airspace allocation unit 102 identifies, from the cells in the flyable airspace, the cell that is closest to the departure point included in the flight schedule (a departure point cell) and the cell that is closest to the destination (a destination cell). Then, flight airspace allocation unit 102 tentatively determines flight airspace that spans from the departure point cell to the destination cell identified from the cells in the flyable flight airspace, and that has the shortest flight distance, for example, and then extracts the cell IDs of the cells included in the tentatively-determined flight airspace.

FIG. 7 illustrates an example of tentatively-determined flight airspace. FIG. 7 illustrates an x axis and a y axis that take the center of cell C01_01 (the cell with a cell ID of C01_01) as the origin, with the direction of the arrow on the x axis called the x axis positive direction, the direction opposite thereto called the x axis negative direction, the direction of the arrow on the y axis called the y axis positive direction, the direction opposite thereto called the y axis negative direction, and the y axis negative direction assumed to be north. The example in FIG. 7 illustrates flight airspace R1 spanning from “warehouse α1” to “store γ1” included in the flight schedule of drone 30a-1 (with a drone ID of D001) illustrated in FIG. 5.

Flight airspace R1 includes: divided airspace R11 (airspace obtained by dividing the flight airspace) from cell C10_06, which is the departure point cell, through the cells adjacent in the y axis positive direction, and to cell C10_20; and divided airspace R12 from cell C10_20, through the adjacent cells in the x axis positive direction, and to cell C39_20. The example in FIG. 7 illustrates bad communication air space B1 that includes cells C17_20 to C23_20 included in divided airspace R12.

Drone 30a-1 to which flight airspace is to be allocated has the avoidance function, and therefore flight airspace allocation unit 102 tentatively determines the cells included in bad communication air space B1 (cells C17_20 to C23_20) as well, as the flight airspace to be allocated to drones 30a-1. In the present embodiment, flight airspace allocation unit 102 tentatively determines the permitted flight period for each divided airspace. For example, flight airspace allocation unit 102 calculates a period obtained by dividing a period, from the estimated departure time to the estimated arrival time included in the flight schedule, according to a ratio based on the length of each divided airspace, as an airspace passage period required when passing through each divided airspace.

For example, if the ratio of the lengths of divided airspaces R11 and R12 in flight airspace R1 is 1:2, and the period from the estimated departure time to the estimated arrival time is 60 minutes, flight airspace allocation unit 102 calculates 20 minutes and 40 minutes as the airspace passage periods for the divided airspaces R11 and R12, respectively. Flight airspace allocation unit 102 tentatively determines, as the permitted flight period in each divided airspace, a period that takes, as a start time or an end time, a time to which a margin period is added before and after times after which the airspace passage periods have passed in sequence following the estimated departure time (i.e., a time after the passage of 20 minutes, and a time after the passage of 60 minutes).

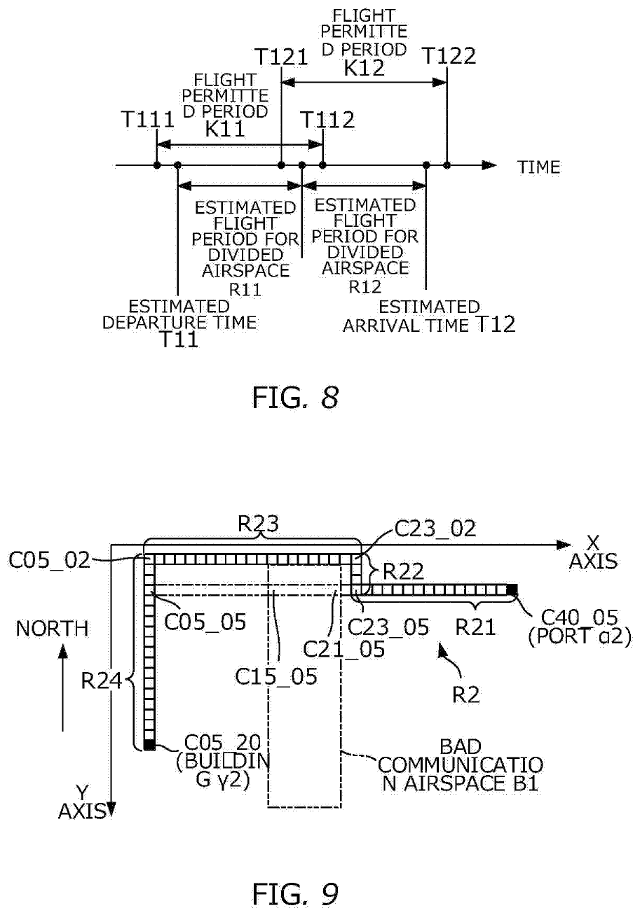

FIG. 8 illustrates an example of tentatively-determined permitted flight periods. With respect to divided airspace R11, assuming the margin period is three minutes, for example, flight airspace allocation unit 102 tentatively determines, as the permitted flight period, period K11, which takes three minutes before estimated departure time T11 as start time T111, and takes a time when the margin period of three minutes has passed following the passage of the airspace passage period (20 minutes) for divided airspace R11 from estimated departure time T11 (i.e., 23 minutes after estimated departure time T1) as end time T112.

With respect to divided airspace R12, flight airspace allocation unit 102 tentatively determines, as the permitted flight period, period K12, which takes a time that is the margin period of three minutes before a time at which 20 minutes, which is the airspace passage period of divided airspace R11, has passed following estimated departure time T11 (i.e., 17 minutes after estimated departure time T1), as start time T121, and which takes a time at which the margin period of three minutes has passed after the passage of 60 minutes corresponding to the airspace passage periods in both divided airspaces R11 and R12 from estimated departure time T11 (i.e., 63 minutes after estimated departure time T1) as end time T122.

FIG. 9 illustrates another example of tentatively-determined flight airspace. The example in FIG. 9 illustrates flight airspace R2 spanning from “port α2” to “building γ2” included in the flight schedule of drone 30b-2 (with a drone ID of D002) illustrated in FIG. 5. It is assumed that the departure point cell is cell C40_05 and destination cell is cell C05_20 in this flight schedule. In this case, if flight airspace that has the shortest flight distance is tentatively determined, the flight airspace inevitably passes through bad communication air space B1 regardless of which cell the flight airspace passes through.

For example, if flight airspace that extends from cell C40_05 to cell C05_05 to the west and from cell C05_05 to cell C05_20 to the south is allocated, flight airspace from cell C21_05 to cell C15_05 passes through bad communication air space B1. Drone 30b-2 does not have the avoidance function, and therefore flight airspace allocation unit 102 does not allocate bad communication air space B1 to drone 30b-2. As such, flight airspace allocation unit 102 allocates flight airspace R2 that detours bad communication air space B1 instead of passing through it.

Flight airspace R2 includes: divided airspace R21 from cell C40_05, which is the departure point cell, through the cells adjacent in the x axis negative direction, and to cell C23_05; divided airspace R22 from cell C23_05, through the adjacent cells in the y axis negative direction, and to cell C23_02; divided airspace R23 from cell C23_05, through the adjacent cells in the x axis negative direction, and to cell C05_02; and divided airspace R24 from cell C05_02, through the adjacent cells in the y axis positive direction, and to cell C05_20, which is the destination cell.

In the example in FIG. 9, flight airspace R2 detours from cell C23_05 that is at a distance of one cell from bad communication air space B1. This is because it is envisaged that the communication quality in cells that are adjacent to bad communication air space B1 is worse than in other cells in the good communication airspace, and such cells are avoided. In contrast, divided airspace R23 passes through cells that are adjacent to bad communication air space B1. This is because if the adjacent cells are avoided, the flight distance from the departure point cell to the destination cell increases.

In this manner, flight airspace allocation unit 102 does not allocate cells that are adjacent to bad communication air space B1 as flight airspace unless the flight distance increases. In the same light, flight airspace allocation unit 102 may allocate cells that are as far away as possible from bad communication air space B1 as flight airspace unless the flight distance increases. In this case, flight airspace allocation unit 102 allocates, to drone 30b-2, flight airspace that immediately extends toward the north from the departure point cell to cell C40_02, and then extends toward the west to cell C05_02.

Flight airspace allocation unit 102 temporarily stores the information tentatively determined in this manner (tentative determination information).

FIG. 10 illustrates an example of the tentative determination information. In FIG. 10, the cell IDs of the cells included in the flight airspace are collected for each divided airspace, the corresponding permitted flight periods are associated with each divided airspace, and the flight airspaces and permitted flight periods are associated with the drone IDs of the tentatively-determined drone 30.

For example, a cell ID group of the cells included in divided airspaces R11 and R12, and the start times and end times of periods K11 and K12, which are the permitted flight periods, are associated with the drone ID “D001” indicating drone 30a-1. A cell ID group of the cells included in divided airspaces R21-R24, and permitted flight periods K21-K24, are associated with the drone ID “D002” indicating drone 30b-2.

Even if flight airspace overlaps at the tentative determination stage, flight airspace allocation unit 102 allocates all the flight airspace as-is. Flight airspace allocation unit 102 determines whether or not to share flight airspace in an overlapping state (overlapping airspace) allocated in such a manner. Accordingly, first, flight airspace allocation unit 102 extracts combinations of drones 30 for which the tentatively-determined flight airspace overlaps. Flight airspace allocation unit 102 calculates the airspace passage period required for passing through the entire flight airspace, and then divides the calculated airspace passage period according to the number of cells included in the flight airspace. The divided periods express periods necessary for drone 30 to pass through each of the cells.

Flight airspace allocation unit 102 calculates times, obtained by sequentially adding the divided periods to the estimated departure time, as a time at which drone 30 is estimated to start flying in a cell (an estimated start time), and a time at which drone 30 is estimated to stop flying in the cell (an estimated stop time). Hereinafter, a period from the start time and the end time calculated for a cell will be called an “estimated flight period” (an estimated period during which drone 30 flies in the cell).

In the present embodiment, if there are overlapping cells that have been tentatively determined to be allocated to two or more drones 30, and the difference between expected flight periods for the overlapping cells (the difference between the estimated flight start times or the difference between the estimated flight stop times) is less than a threshold, flight airspace allocation unit 102 extracts the combination of those drones 30 as a combination of drones 30 for which the flight airspace overlaps. For example, if drones 30 thus extracted fly in the same direction, flight airspace allocation unit 102 determines that the overlapping airspace is to be shared, and if drones 30 thus extracted fly in different directions, flight airspace allocation unit 102 determines that the overlapping airspace is not to be shared.

If the overlapping airspace is to be shared, flight airspace allocation unit 102 determines that the overlapping airspace is to be officially allocated as-is to the plurality of extracted drones 30. If the overlapping airspace is not to be shared, flight airspace allocation unit 102 determines that the overlapping airspace is to be allocated as-is to drone 30 with the earliest expected flight period in the overlapping airspace (if a plurality of cells constitute the overlapping airspace, the earliest expected flight periods among a plurality of expected flight periods are compared with each other).

For drone 30 to which the overlapping airspace has not been allocated, flight airspace allocation unit 102 withdraws the allocation of the tentatively-determined flight airspace, and instead allocates different flight airspace (also tentatively-determined), i.e., revises the flight airspace to be allocated. At this time, flight airspace allocation unit 102 allocates the new flight airspace from airspace aside from airspace for which the official allocation has been finalized. In this manner, flight airspace allocation unit 102 allocates flight airspace to all drones 30 for which allocation is requested, by repeating the tentative determination, revision, and finalization of the allocation.

Once the flight airspace allocations have been finalized for all drones 30 through the above-described method, flight airspace allocation unit 102 supplies the tentative determination information from the time of the finalization, as allocation information indicating the official flight airspace and permitted flight periods, to allocation information transmission unit 105. Official flight airspace and permitted flight periods are allocated in this manner, and thus a plan on the basis of which drones fly according to the allocated flight airspace (a flight plan) is made. Allocation information transmission unit 105 transmits the supplied allocation information to business operator terminal 20 used by the operation manager of drone 30 having the drone ID included in that allocation information.

Because airspace is limited, if the number of drones 30 requesting airspace allocation is too high, a situation in which flight airspace cannot be allocated to some drones 30 may arise. In such a case, flight airspace allocation unit 102 includes information, which associates the drone ID of drone 30 for which it has been determined that airspace cannot be allocated with an indication that the allocation is not possible, in the allocation information so as to notify business operator terminal 20 that the allocation was not carried out. For that drone 30, the aforementioned operation manager inputs a new flight schedule and requests the allocation of flight airspace again, for example.

Allocation information obtainment unit 204 of business operator terminal 20 obtains the allocation information that has been transmitted and supplies that information to flight control information generation unit 205. Flight control information generation unit 205 generates the above-described flight control information (a group of information for drone 30 to control its own flight).

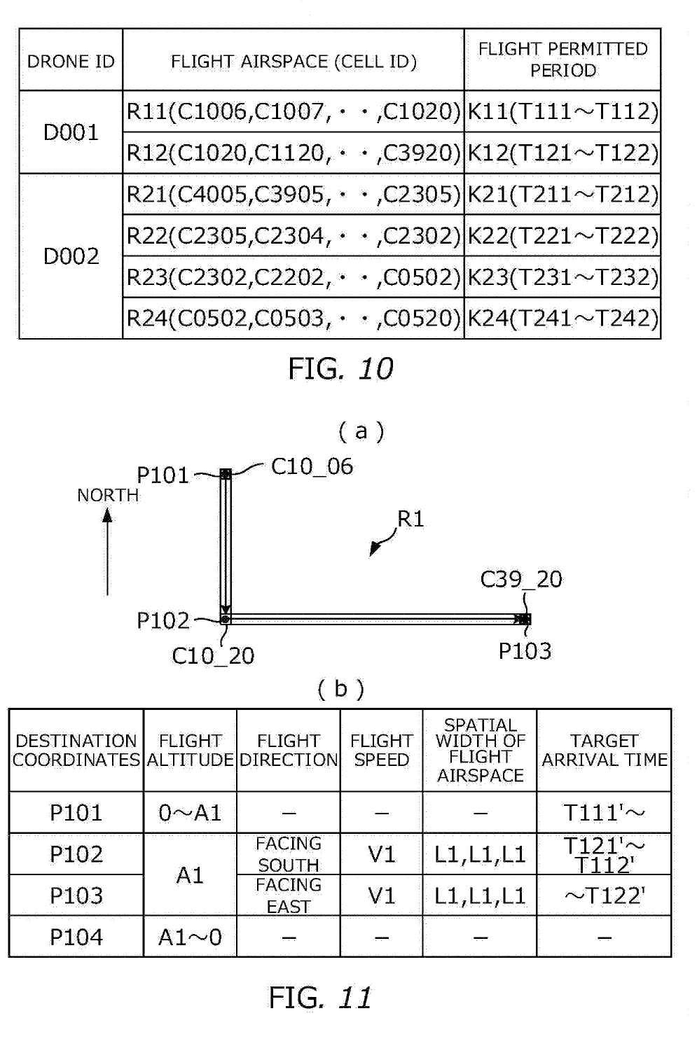

FIG. 11 illustrates an example of the generated flight control information. FIG. 11 illustrates the flight control information for the above-described drone 30a-1.

As illustrated in FIG. 11(a), flight airspace from cell C10_06, which is the departure point cell, turning at cell C10_20, and then arriving at cell C39_20, which is the destination cell, is allocated to drone 30a-1. First, flight control information generation unit 205 calculates coordinates P101, P102, and P103 of the center points of these three cells as target point coordinates (coordinates of target points to be arrived at next), and generates the flight control information including those coordinates.

In drone operation management system 1, a drone port where drone 30 can land is prepared at the point designated as the destination, and business operator terminal 20 stores the coordinates of each drone port in association with the name of the destination. In the example in FIG. 11, flight control information generation unit 205 adds coordinates P104 of the drone port associated with “store γ1”, which is the destination of drone 30a-1, to the flight control information as the target point coordinates.

Flight control information generation unit 205 adds, to the flight control information, the flight altitude, flight direction, flight speed, spatial width, and target arrival time when flying to each of the target point coordinates. As, for example, the flight altitude, flight control information generation unit 205 adds “0-A1” to the flight to coordinates P101 (takeoff); “A1”, to the flight up to coordinates P103 following thereafter (horizontal flight); and “A1-0”, to the flight up to coordinates P104 (landing).

Additionally, as the flight direction, flight control information generation unit 205 adds “facing south” from coordinates P101 to coordinates P102, in which the horizontal flight is carried out, and “facing east” from coordinates P102 to coordinates P103. Furthermore, as the flight speed from P101 to P103, in which the horizontal flight is carried out, flight control information generation unit 205 adds average speed V1 when flying in the flight airspace during a period from estimated departure time T11 to estimated arrival time T12 included in the flight schedule, for example.

Furthermore, flight control information generation unit 205 adds length L1 of one side of the cell, as defined in the present embodiment, as the spatial width of the flight airspace from coordinates P101 to coordinates P103, in which the horizontal flight is carried out. The three spatial widths “L1, L1, L1” indicated in FIG. 11 refer to widths in three directions, namely the x axis direction, the y axis direction, and the z axis direction. The flight direction, flight speed, and spatial width are not needed during takeoff and landing and are therefore left blank.

Additionally, flight control information generation unit 205 adds a time using the estimated departure time T11 and estimated arrival time T12, and the start time and end time of the permitted flight period, as the target arrival time for each of the target point coordinates. For example, as the target arrival time for coordinates P101, flight control information generation unit 205 defines time T111′, which follows, by a predetermined amount of time, start time T111 of period K11, which is the permitted flight period for divided airspace R11 starting from cell C10_06 that includes coordinates P101.

Entering cell C10_06 before start time T111 corresponds to entry prior to period K11, which is the permitted flight period, and thus time T111′ expresses a time that has passed following start time T111 by an amount of time longer than the amount of time required to arrive at coordinates P101 after entering cell C10_06. Arriving after time T111′ corresponds to entering divided airspace R11 once in period K11, which is the permitted flight period.

Additionally, as the target arrival time for coordinates P102, which correspond to the boundary between divided airspaces R11 and R12, flight control information generation unit 205 defines a time from time T121′, which follows, by a predetermined amount of time, start time T121 of the permitted flight period of divided airspace R12 starting from cell C10_20 that includes coordinates P102, to time T112′, which precedes, by a predetermined amount of time, end time T112 of the permitted flight period of divided airspace R11 that ends at cell C10_20.

Like time T111′, arriving at coordinates P102 after time T121′ corresponds to entering divided airspace R12 once in period K12, which is the permitted flight period. It is assumed that time T112′ expresses a time that has passed following end time T112 by an amount of time longer than the amount of time required to exit cell C10_20 from coordinates P102. Arriving at coordinates P102 before time T112′ means that if the flight is continued, divided airspace R11 can be exited before period K11, which is the permitted flight period, ends.

As the target arrival time at coordinates P103, flight control information generation unit 205 defines a time before time T122′, which precedes, by a predetermined amount of time, end time T122 of period K12, which is the permitted flight period of divided airspace R12 that ends at cell C39_20 including coordinates P103. Arriving at coordinates P103 before time T122′ means that if the flight is continued, divided airspace R12 can be exited before period K12, which is the permitted flight period, ends. Flight control information generation unit 205 supplies the flight control information generated in this manner to flight control information transmission unit 206.

Flight control information transmission unit 206 transmits the supplied flight control information to the target drone 30. Flight control information obtainment unit 301 of drone 30 obtains the flight control information that has been transmitted and supplies the obtained flight control information to flight control unit 303. Flight unit 302 is a function for causing the host device (that drone) to fly. In the present embodiment, flight unit 302 causes the host device to fly using the rotors, driving means, and so on included in flying unit 35.

Flight control unit 303 controls flight unit 302, and, in the present embodiment, carries out a flight control process of causing the host device to fly according to a flight plan or a flight instruction. Flight control unit 303 carries out flight control on the basis of the flight control information supplied from flight control information obtainment unit 301, thereby causing the host device to fly according to a flight plan. Flight control unit 303 also carries out flight control on the basis of a flight instruction from flight instruction unit 106 of server apparatus 10 described below, thereby causing the host device to fly according to the flight instruction.

Position measurement unit 304 measures the position of the host device, and supplies position information indicating the measured position (e.g., latitude/longitude information) to flight control unit 303. Altitude measurement unit 305 measures the altitude of the host device, and supplies altitude information indicating the measured altitude (e.g., information indicating the altitude in cm) to flight control unit 303. Direction measurement unit 306 measures the direction in which the front of the host device is facing, and supplies direction information indicating the measured direction (e.g., when true north is taken as 0 degrees, information indicating an angle to 360 degrees from each direction) to flight control unit 303.

Obstacle measurement unit 307 uses the object recognition sensor included in sensor unit 36 to measure the distance between an obstacle, which is present in the periphery of the host device, to the host device, and the direction of the obstacle, and supplies obstacle information indicating the measured distance and direction to flight control unit 303. The position information, altitude information, direction information, and obstacle information described above are repeatedly supplied to flight control unit 303 every predetermined interval of time (e.g., every one second).

Flight control unit 303 controls the flight of the host device on the basis of the repeatedly-supplied position information, altitude information, and direction information, as well as obstacle information when drone 30 includes obstacle measurement unit 307, in addition to the above-described flight control information. Flight control unit 303 controls the altitude of the host device so that the measured altitude remains at the flight altitude indicated by the flight control information, for example (altitude control). Flight control unit 303 also controls the flight speed of the host device so that changes in the measured position, i.e., the speed, remains at the flight speed indicated by the flight control information (speed control).

Flight control unit 303 also controls the flight altitude and the flight direction so that the host device stays within a quadrangular (square, in the present embodiment) range centered on coordinates of a line connecting the previous target point coordinates with the next target point coordinates (airspace passage control). This quadrangle expresses the boundaries of the flight airspace, corresponds to cross-section when the flight airspace is segmented by a plane orthogonal to the travel direction, and has a length on one side corresponding to the spatial width of the flight airspace.

Flight control unit 303 controls the host device on the basis of the measured position and altitude, and the dimensions of the host device (vertical dimensions and horizontal dimensions) so that the host device stays within the quadrangular range. When the target point coordinates approach, flight control unit 303 controls the flight speed so as to reduce the flight speed if the arrival will be before the target arrival time and increase the flight speed if the arrival will be after the target arrival time (arrival control). If the host device includes obstacle measurement unit 307, and the measured distance to the obstacle has fallen below a threshold, flight control unit 303 avoids a collision with the obstacle that has approached by changing the flight direction to avoid the direction of the obstacle measured at that time, changing the flight speed, or the like (obstacle avoidance control). In this case, flight control unit 303 functions as the “function of avoiding a collision with an obstacle” according to the present invention.

The flight control unit 303 supplies the supplied position information and altitude information to flight status notification unit 308. Flight status notification unit 308 generates, as the above-described flight status information, information associated with spatial coordinates expressed by the position indicated by the supplied position information and the altitude indicated by the supplied altitude information, the current time, and the drone ID of the drone, every predetermined interval of time. Each time flight status notification unit 308 generates flight status information, flight status notification unit 308 transmits the generated flight status information to server apparatus 10 and business operator terminals 20 to notify them of the flight status.

Flight status display unit 207 of business operator terminal 20 displays the flight status indicated by the flight status information transmitted from drone 30. The operation manager of drone 30 checks the displayed flight status to confirm that drone 30 is flying in the allocated flight airspace, drone 30 is flying without delay from the permitted flight period, and so on. For example, if drone 30 is significantly delayed from a flight plan (a plan to fly according to the allocated flight airspace and the permitted flight period), the operation manager determines whether or not drone 30 can return to the flight that is on the basis of the flight plan.

For example, if the operation manager determines that there is a high likelihood that a failure has occurred in light of the degree of delay, the operation manager operates business operator terminal 20 to instruct drone 30 to, for example, make a return flight (return to the departure point) or to make an emergency landing (land at an unplanned landing point, which is, for example, a riverbank, a branch office of the business operator, or the like). In the case of the instruction to make a return flight, the operation manager selects whether the drone should return through the same flight airspace or fly through other airspace. In the case of the instruction to make an emergency landing, the flight airspace inputs the position of the landing point, and, if possible, the flight path to the point.

Flight instruction request unit 208 requests server apparatus 10 to make an instruction to drone 30 according to the flight instruction made by the operation manager. Flight instruction request unit 208 makes this request by transmitting request data that expresses the drone ID of the target drone 30 and the content of the flight instruction, to server apparatus 10. Request data is supplied to flight instruction unit 106 of server apparatus 10. Allocation information is also supplied to flight instruction unit 106 from flight airspace allocation unit 102.

Flight instruction unit 106 of server apparatus 10 makes an instruction regarding a flight (flight instruction) to drone 30. If flight instruction unit 106 receives request data transmitted from business operator terminal 20, for example, flight instruction unit 106 transmits flight instruction data indicating the requested flight instruction (a return flight, an emergency landing, etc.) to drone 30 indicated by the request data. If the request data does not indicate a new flight path, flight instruction unit 106 determines an emergency flight path such that it does not overlap flight airspace of another drone 30 indicated by allocation information, if possible, or otherwise such that the expected flight periods in the overlapping cells are shifted from each other by a predetermined period or more, and transmits flight instruction data indicating the flight airspace.

Upon receiving the flight instruction that has been transmitted, flight control unit 303 of drones 30 carries out flight control, preferentially following the flight instruction indicated by flight instruction date rather than flight control information (i.e., preferentially following the flight instruction rather than the flight plan). For example, if a flight instruction indicating a return flight is made, flight control unit 303 carries out flight control to fly to the departure point in the reverse flight direction through the flight airspace that drone 30 has travelled, and if a flight instruction indicating an emergency landing is made, flight control unit 303 carries out flight control to fly to the landing point specified by the instruction.

Flight status obtainment unit 107 of server apparatus 10 obtains flight statuses indicated by the flight status information transmitted from drones 30, and supplies the obtained flight statuses to flight instruction unit 106. Flight instruction unit 106 determines whether or not each drone 30 is flying according to the flight plan (the allocated flight airspace), on the basis of the supplied flight status. For example, if a flight status indicates that drone 30 is likely to exit flight airspace within the permitted flight period, flight instruction unit 106 instructs that drone 30 to increase the flight speed, or if drone 30 is flying outside flight airspace, flight instruction unit 106 instructs that drone 30 to change the flight direction toward the flight airspace.

If there is drone 30 that is flying according to a flight instruction through flight airspace different from that specified by the flight plan, basically, that drone 30 should be given a flight instruction to avoid approaching other drones 30. However, compared to a case where drone 30 flies according to a flight plan, drone may approach closer to another drone 30 (come into a near-miss state) because flight airspace has been urgently determined. In such a case, flight instruction unit 106 may also supply other drones 30 with a flight instruction to increase or decrease the flight speed to resolve the near-miss state.

On the basis of the configuration described above, the apparatuses included in drone operation management system 1 carries out an allocation process for allocating flight airspace and permitted flight periods to drones 30.

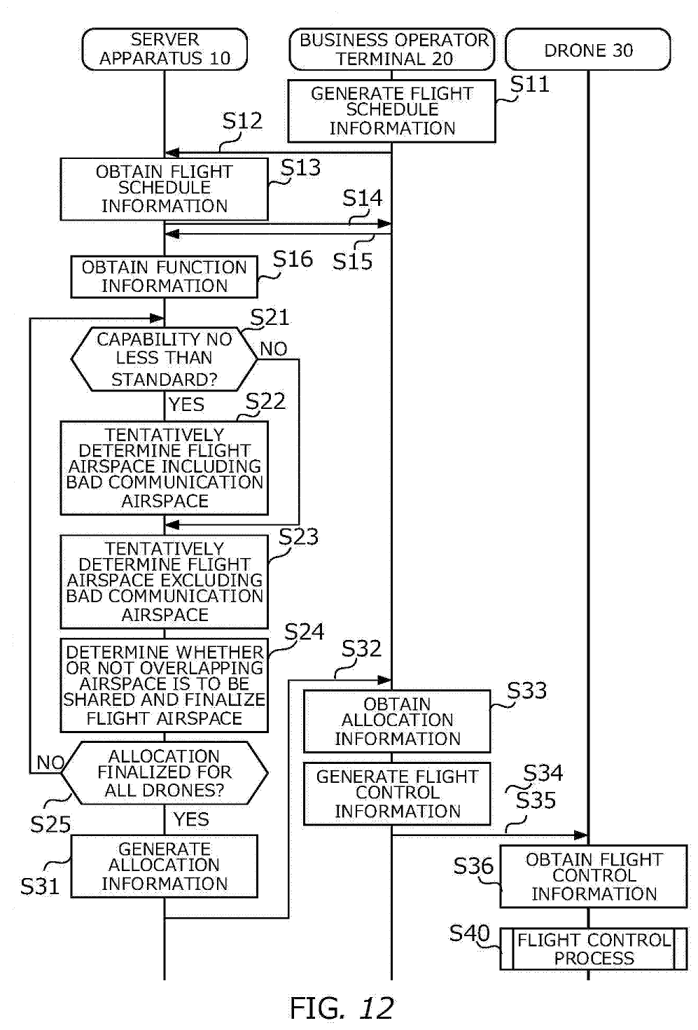

FIG. 12 illustrates an example of operation sequences carried out by the apparatuses in the allocation process. This operation sequence is started upon an operator of drone 30 inputting the flight schedule into business operator terminal 20, for example. First, business operator terminal 20 (flight schedule generation unit 201) generates the flight schedule information as illustrated in FIG. 5 (step S11).

Next, business operator terminal 20 (flight schedule transmission unit 202) transmits the generated flight schedule information to server apparatus 10 (step S12). Server apparatus 10 (flight schedule obtainment unit 101) obtains the flight schedule information transmitted from business operator terminal 20 (step S13). Then, server apparatus 10 (function information obtainment unit 104) requests business operator terminal 20 for function information regarding drone 30 for which the flight schedule is indicated by the obtained flight schedule information (step S14).

Next, business operator terminal 20 (function information storage unit 203) transmits the requested function information regarding drone 30 to server apparatus 10 (step S15). Server apparatus 10 (function information obtainment unit 104) obtains the function information that has been transmitted (step S16). Note that operations through steps S14 to S16 may be carried out in advance of this operation sequence. Also, business operator terminal 20 (function information storage unit 203) may transmit function information when flight plan information is transmitted in S12, even if a request is not made in step S14.

Next, server apparatus 10 (flight airspace allocation unit 102) determines whether or not the capabilities of drone 30 indicated by the obtained function information are no lower than the predetermined standard (step S21). Upon determining that the capabilities are no lower than the standard (YES), server apparatus 10 (flight airspace allocation unit 102) tentatively determines flight airspace (flight airspace and permitted flight periods) such that not only a good communication airspace but also a bad communication airspace is allocated (step S22), and upon determining that the capabilities are no lower than the standard NO), server apparatus 10 tentatively determines flight airspace such that a bad communication airspace is not allocated and only a good communication airspace is allocated (step S23).

Next, if the tentatively-determined flight airspace includes overlapping airspace, server apparatus 10 (flight airspace allocation unit 102) determines whether or not the overlapping airspace is to be shared (step S24). If the overlapping airspace is to be shared, server apparatus 10 (flight airspace allocation unit 102) finalizes the allocation of the flight airspace including the overlapping airspace, and if the overlapping airspace is not to be shared, server apparatus 10 selects drone 30 to which the overlapping airspace is to be allocated, and finalizes flight airspace for that drone 30. Then, server apparatus 10 determines whether or not the allocation has been finalized for all drones 30 (step S25), and carries out the processing from step S21 again if it is determined that the allocation has not been finalized (NO).

If it is determined in step S25 that the allocation is finalized (YES), server apparatus 10 (flight airspace allocation unit 102) generates the allocation information as indicated in FIG. 10, in which the tentatively-determined flight airspace and permitted flight periods are finalized as official (step S31), and transmits the generated allocation information to business operator terminal 20 (step S32). Business operator terminal 20 (allocation information obtainment unit 204) obtains the transmitted allocation information (step S33).

Next, business operator terminal 20 (flight control information generation unit 205) generates the flight control information as illustrated in FIG. 11 on the basis of the obtained allocation information (step S34). Business operator terminal 20 (flight control information transmission unit 206) transmits the generated flight control information to the target drone 30 (step S35). Drone 30 (flight control information obtainment unit 301) obtains the transmitted flight control information (step S36). Drone 30 carries out the above-described flight control processing on the basis of the obtained flight control information (step S40).

In drone operation management system 1, as described above, drone 30 flies while communicating with base stations 3 to notify server apparatus 10 of the position of that drone 30, and, if necessary, to receive a flight instruction, and thus drone 30 can manage unexpected situations when flying. However, if a bad communication airspace is included in flight airspace, drone 30 needs to fly through the bad communication airspace in a state where a flight instruction cannot be received. However, if a bad communication airspace is not allocated at all so that drone 30 can avoid flying in a state where a flight instruction cannot be received, limited flyable airspace becomes even narrower.

In the present embodiment, not only a good communication airspace, but also a bad communication airspace is allocated to drone 30 whose capabilities are no lower than a standard (drone 30 is determined as an allocation target). Accordingly, even if airspace that can be allocated to drone 30 (flyable airspace) includes a portion in which communication quality is worse than in other airspace (a bad communication airspace), the entire airspace can be more effectively used than in a case where the bad communication airspace is not allocated to any of drones 30.

Also, in the present embodiment, a target to which a bad communication airspace is allocated as flight airspace is limited to drone 30 that has the capabilities of avoiding a collision (the function of avoiding a collision with an obstacle) when a near miss with another drone 30 occurs. Accordingly, compared to a case where a bad communication airspace is allocated to all drones 30, the safety of drone 30 to which a bad communication airspace is allocated can be increased (a likelihood that drone 30 can fly without colliding with an obstacle (which may be another drone) can be increased).

### 2. Variations

The above-described embodiment is merely one example for carrying out the present invention, and the following variations are possible as well.

### 2-1. Flight Airspace

In the embodiment, flight airspace allocation unit 102 allocates the flight airspace using cubic cells, but the flight airspace may be allocated using a different method. For example, flight airspace allocation unit 102 may use parallelepiped cells instead of cubic cells, or may arrange cylindrical cells with their axes following the travel direction and use those cells as the flight airspace. Instead of cells, flight airspace allocation unit 102 may allocate flight airspace by expressing points, lines, and planes serving as the boundaries of the flight airspace through equations and ranges of spatial coordinates.

Additionally, in the embodiment, flight airspace allocation unit 102 allocates flight airspace including only cells of a constant height, as indicated in FIG. 6. However, flight airspace including cells of different heights (flight airspace including movement in the vertical direction) may be allocated as well. Furthermore, in the embodiment, flight airspace allocation unit 102 allocates flight airspace that uses east, west, south, and north as the travel directions. However, flight airspace that uses other directions (north-northeast, west-southwest, and so on) as travel directions may be allocated, and flight airspace including angular climbs and descents may be allocated as well. In sum, flight airspace allocation unit 102 may allocate any airspace as the flight airspace as long as it is airspace in which drone 30 can fly.

### 2-2. Flight Result

Flight airspace allocation unit 102 may determine drone 30 to which a bad communication airspace is to be allocated, using a method different from that in the embodiment. In the present variation, flight airspace allocation unit 102 determines that the capabilities of drone 30 are no lower than the predetermined standard when the difference between the flight plan and the flight result is less than a threshold.

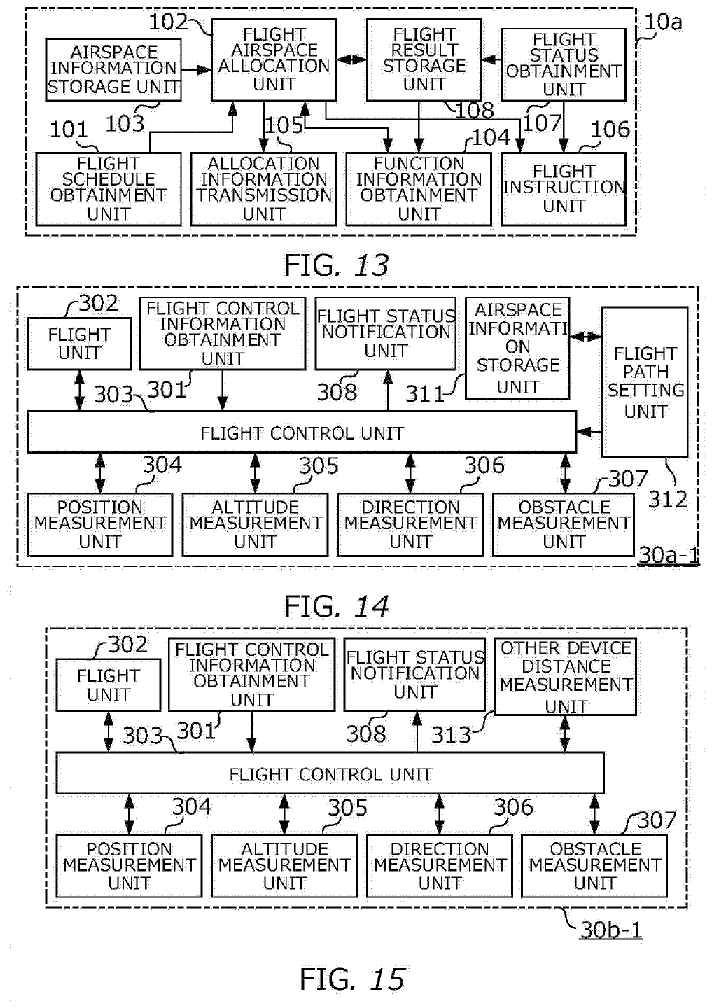

FIG. 13 illustrates a functional configuration realized by server apparatus 10a according to the present variation. Server apparatus 10a includes flight result storage unit 108 in addition to the units illustrated in FIG. 4. Flight result storage unit 108 stores the results of flight of drones 30. In the present variation, upon flight airspace allocation unit 102 finalizing the allocation of flight airspace to all drones 30, allocation information is supplied to flight result storage unit 108.

Also, each time flight status obtainment unit 107 obtains a flight status (information indicating spatial coordinates, the current time, and a drone ID), flight status obtainment unit 107 supplies the flight status to flight result storage unit 108. Flight result storage unit 108 stores the supplied flight status as the flight result of drone 30 that has transmitted the flight status, in association with allocation information that has been supplied thereto. This allocation information is information indicating flight airspace and permitted flight periods that have been allocated to drone 30, i.e., a flight plan.

When tentatively determining the allocation of flight airspace, flight airspace allocation unit 102 reads out the flight plan and flight result of the target drone 30 from flight result storage unit 108. Then, flight airspace allocation unit 102 calculates the difference between the flight plan and the flight result that have been read out. For example, flight airspace allocation unit 102 calculates, as the difference, time by which drone 30 flies through flight airspace longer than a permitted flight period indicated by the flight plan (an out-of-period flight time). Flight airspace allocation unit 102 also calculates, as the difference, a distance by which drone 30 flies longer than flight airspace indicated by the flight plan (an out-of-airspace flight distance).

For example, flight airspace allocation unit 102 calculates, as a value indicating the difference between the flight plan and the flight result, the sum of a value obtained by multiplying the calculated out-of-period flight time by a coefficient K1 and a value obtained by multiplying the calculated out-of-airspace flight distance by a coefficient K2 (K1 and K2 are predetermined coefficients). If the value of the calculated difference is less than a threshold, flight airspace allocation unit 102 determines that the difference between the flight plan and the flight result is less than the threshold. The capabilities of drone 30 for which the difference is less than the threshold are no lower than the predetermined standard, and therefore flight airspace allocation unit 102 allocates not only a good communication airspace, but also a bad communication airspace, to the drone.

In the present variation, the capabilities of drone 30 are determined on the basis of the flight result of a flight that has been actually carried out. Therefore, for example, even in a case of drones 30 that are the same products and have the same functions, if their capabilities are different due to the deterioration of a part, a minor failure, or the like, it is possible to determine whether or not to allocate a bad communication airspace in view of such a difference. Also, in the present variation, if drone 30 can fly more pursuant to the flight plan, the capabilities of that drone 30 are determined to be higher. Therefore, a bad communication airspace is allocated to such drone 30 with high capabilities, and thus drone 30 to which a bad communication airspace has been allocated is more likely to follow its flight plan than in a case where a bad communication airspace is allocated to all drones 30.

Note that flight statuses that are to be obtained by flight status obtainment unit 107 include a status of a flight carried out according to a flight instruction, and such a status may not be suitable for evaluating whether or not drone 30 could fly according to the flight plan (i.e., whether or not drone 30 could stably fly through a bad communication airspace) without a flight instruction. Therefore, flight status obtainment unit 107 may obtain a flight status including information regarding whether or not a flight instruction has been made, and flight airspace allocation unit 102 may determine the above-described capabilities, using only the flight result of a flight carried out without a flight instruction. As a result, it is possible to more accurately determine the capabilities of drone 30 than in a case where the flight result of a flight carried out according to a flight instruction is used as well.

### 2-3. Path Setting Function

Flight airspace allocation unit 102 may determine drone 30 to which a bad communication airspace is to be allocated, using a method different from that in the embodiment. In the present variation, if drone 30 has the function of setting the path to the destination (a path setting function), flight airspace allocation unit 102 determines that the capabilities of that drone 30 are no lower than the predetermined standard.

The path mentioned here is not a simple straight flight path to the destination, but is a path to the destination through flyable airspace because airspace includes flyable airspace and non-flyable airspace. In the present variation, it is assumed that drone 30a-1 has the path setting function, for example.

FIG. 14 illustrates a functional configuration realized by drone 30a-1 according to the present variation. Drone 30a-1 includes airspace information storage unit 311 and flight path setting unit 312 in addition to the units illustrated in FIG. 4.

Airspace information storage unit 311 stores, as airspace information regarding each airspace in flyable airspace, the airspace information illustrated in FIG. 6 except for communication quality, for example. This airspace information is supplied from the supplier of drone operation management system 1 to the business operators. When the destination has been determined, flight path setting unit 312 sets the flight path from the current position to the destination. Flight path setting unit 312 sets the flight path in the same method as flight airspace allocation unit 102, for example.

Specifically, flight path setting unit 312 reads airspace information from airspace information storage unit 311, and specifies a cell that is closest to the current position (a current position cell) and a cell that is closest to the destination (a destination cell) from among the cells in flyable airspace. Next, flight path setting unit 312 extracts the cell IDs of cells on the flight path that extends from the specified departure point cell to the specified destination cell, and of which the flight distance is the shortest, for example, from among the cells in flyable airspace. Flight path setting unit 312 sets a flight path that passes through the cells indicated by the cell IDs extracted in this manner.

In this manner, the flight path setting unit 312 sets a flight path that passes through flyable airspace (i.e., a flight path that does not pass through non-flyable airspace). The presence or absence of the path setting function is indicated by the function information described in the embodiment, for example. If the function information supplied from function information obtainment unit 104 indicates that drone 30 has the path setting function, i.e., if drone 30 to which airspace is to be allocated has the path setting function, flight airspace allocation unit 102 determines that the capabilities of that drone 30 are no lower than the predetermined standard, and allocates not only a good communication airspace, but also a bad communication airspace, to that drone 30.

For example, if a failure occurs in drone 30 and drone 30 falls into a state of being unable to reach the destination, a flight instruction that indicates emergency landing at a nearby landing point, and a flight path from the current position to the landing point, may be transmitted from server apparatus 10 to that drone 30. However, in a bad communication airspace, drone 30 cannot receive the flight instruction or the flight path. If landing points at which emergency landing can be carried out are stored in drone 30 in advance, the landing point that is closest to the current position can be determined.

However, regarding the flight path from the current position to the landing point, if drone 30 does not have the path setting function, such drone 30 can only fly straight from the current position to the landing point. As a result, drone 30 may pass through non-flyable airspace and commit a dangerous and serious violation. In the present variation, a bad communication airspace is only allocated to drone 30 that has the path setting function. Therefore, even if the destination is urgently changed, drone 30 can safely fly to the new destination along a flight path that passes through flyable airspace, without committing a violation.

### 2-4. Formation Flight Function

Flight airspace allocation unit 102 may determine drone 30 to which a bad communication airspace is to be allocated, using a method different from that in the embodiment. In the present variation, if drone 30 has the function of carrying out a formation flight (a formation flight function), flight airspace allocation unit 102 determines that the capabilities of that drone 30 are no lower than the predetermined standard.

In the present variation, it is assumed that drone 30b-1 has the formation flight function.

FIG. 15 illustrates a functional configuration realized by drone 30b-1 according to the present variation. Drone 30b-1 includes other device measurement unit 313 in addition to the units illustrated in FIG. 4. Other device measurement unit 313 measures the distance between another drone 30, which is present in the periphery of the host device, and the host device. Other device measurement unit 313 repeatedly measures the distance to drone 30 that is present in the travel direction of the host device every predetermined interval of time, and supplies distance information indicating the measured distance, to flight control unit 303.

Flight control unit 303 carries out control (formation maintenance control) to adjust the flight speed and the flight direction such that the measured distance to the other device (the interval between drones 30) falls within a predetermined range. In this case, flight control unit 303 functions as the formation flight function. The presence or absence of the formation flight function is indicated by the function information described in the embodiment, for example. Flight airspace allocation unit 102 determines whether or not the function information supplied from function information obtainment unit 104 indicates the presence of formation flight function.

If function information indicates that drone 30 has the formation flight function, i.e., if drone 30 to which airspace is to be allocated has the formation flight function, flight airspace allocation unit 102 determines that the capabilities of that drone 30 are no lower than the predetermined standard, and allocates not only a good communication airspace, but also a bad communication airspace, to that drone 30. Drone 30 that has the formation flight function necessarily has the function of keeping the distance to another drone 30 constant, such drone 30 can also detect another drone 30 when it has approached thereto.

For example, if another drone 30 flies along a flight path different from that indicated by the flight plan due to a failure or the like and a near miss is about to occur, drone 30 that has the formation flight function can avoid a collision without a flight instruction from server apparatus 10. Therefore, it is possible to increase the safety of drone 30 to which a bad communication airspace, compared to a case where a bad communication airspace is allocated to all drones 30.

### 2-5. Allocation Distance of Bad Communication Airspace

Flight airspace allocation unit 102 may allocate a bad communication airspace, using a method different from that in the embodiment. In the present variation, flight airspace allocation unit 102 sets the upper limit of the flight distance of a bad communication airspace in the flight airspace that is to be allocated to drone 30 that satisfies the above-described allocation conditions (conditions for drones to which a bad communication is to be allocated), to a distance corresponding to the level of the capabilities of that drone 30.

In the present variation, drone 30 has one or more capabilities of four capabilities that are effective during a flight in a bad communication airspace, namely the capability of avoiding an obstacle that drone 30 with the above-described avoidance function has, the capability of setting a path that drone 30 with the path setting function has, the capability of carrying out a formation flight that drone 30 with the formation flight function has, and the capability of keeping the difference between the flight plan and the flight result to be less than the threshold.

Flight airspace allocation unit 102 stores a flight distance table in which the number of effective capabilities that drone 30 has and the upper limit of the flight distance in a bad communication airspace are associated with each other.

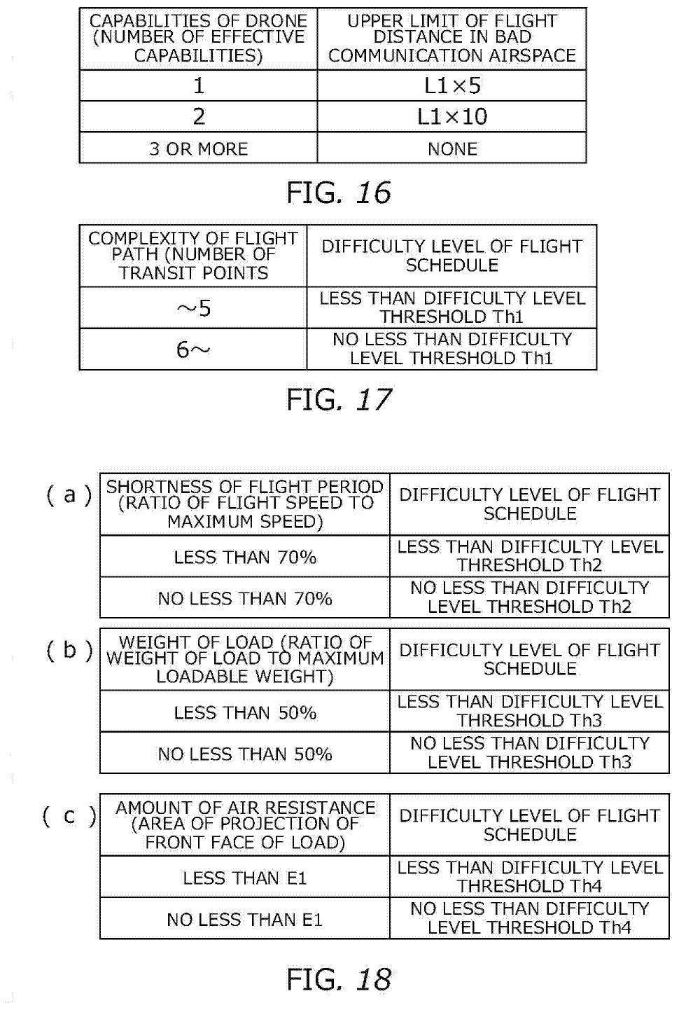

FIG. 16 illustrates an example of the flight distance table. In the example in FIG. 16, association is established such that the upper limit of the flight distance is “L1×5” when there is one effective capability, the upper limit of the flight distance is “L1×10” when there are two effective capabilities, and the upper limit is “none” when there are three or more effective capabilities.

The distance “L1” is the length of the sides of one cell, and L1×5 expresses the distance corresponding to five cells. In the present variation, drone 30 includes function information obtainment unit 104 and flight result storage unit 108 illustrated in FIG. 13. Flight airspace allocation unit 102 determines how many functions, of the avoidance function, the path setting function, and the formation flight function, are indicated by function information supplied from function information obtainment unit 104. Also, flight airspace allocation unit 102 reads out the flight plan and flight result of the target drone 30 from the flight result storage unit 108, and determines whether or not the difference between the flight plan and the flight result is less than the threshold.

If the difference between the flight plan and the flight result is less than the threshold, flight airspace allocation unit 102 determines a number obtained by adding one to the number of functions indicated by the function information as the number effective capabilities. Flight airspace allocation unit 102 sets the upper limit of the flight distance in a bad communication airspace to the upper limit of the flight distance associated with, in the flight distance table, the number of effective capabilities thus determined, to allocate flight airspace. For example, if the number of effective capabilities of the target drone 30 is two, flight airspace allocation unit 102 limits the number of cells included in a bad communication airspace to be no greater than 10 to allocate flight airspace.

In this manner, flight airspace allocation unit 102 increases the distance by which drone 30 is permitted to fly (increases the upper limit of the flight distance in a bad communication airspace) as the number of effective capabilities of drone 30 increases, i.e., as the level of the capabilities of drone 30 increases, to allocate flight airspace. Note that flight airspace allocation unit 102 may set the upper limit of the flight time in a bad communication airspace to a flight time corresponding to the level of the capabilities of drone 30.

However, in order to determine the time for which drone 30 is permitted to pass through a bad communication airspace, it is necessary that the flight speed of drone 30 has been determined, and if the flight speed has been determined, the upper limit of the passing time can be replaced with the upper limit of the passing distance. Setting the upper limit of the flight distance in a bad communication airspace to a flight distance corresponding to the level of the capabilities of drone 30 is the same as setting the upper limit of the flight time in a bad communication airspace to a flight time corresponding to the level of the capabilities of drone 30.

The larger the number of effective capabilities described above is, the more safely or more pursuant to the flight plan drone 30 can fly when an unexpected situation occurs during a flight in a bad communication airspace. In the present variation, the upper limit of the flight distance (or the flight time) in a bad communication airspace is increased according to the level of the capabilities of drone 30. Thus, it is possible to prevent the likelihood of safety or a flight pursuant to the flight plan in a bad communication airspace from decreasing while more effectively using the entire airspace compared to a case where a bad communication airspace is allocated to all drones 30 that have at least one effective capability, without limitation.

2-6. Flight Schedule that Cannot Be Easily Followed

Flight schedules created by business operators include flight schedules that can be easily followed (easy flight schedules) and flight schedules that cannot be easily followed (difficult flight schedules). For example, a flight schedule in which many transit points are specified and the flight path is complex, and a flight schedule in which the flight periods are tight (e.g., a flight schedule that can be achieved only when drone 30 travels at the highest speed) are difficult flight schedules.

Also, if drone 30 carries a luggage, and the weight and shape of the luggage is included in a flight schedule, a flight schedule that demands that drone 30 carries a luggage with a weight that is approximately the same as the maximum loadable weight of that drone 30, and a flight schedule that involves a luggage with a shape that is likely to be subjected to a large amount of air resistance, are difficult flight schedules. Drone 30 that flies through flight airspace allocated on the basis of such a difficult flight schedule is likely to temporally or positionally depart from a flight plan (a plan on the basis of which drone 30 flies according to the allocated flight airspace) compared to drone 30 that flies through flight airspace allocated on the basis of an easy flight schedule.

As a result, drone 30 may collide with another drone 30 that flies according to the flight plan (through the allocated flight airspace). Therefore, the above-described flight instruction is made to avoid such a collision. However, in a bad communication airspace, such a flight instruction cannot be carried out. Therefore, in the present variation, flight airspace allocation unit 102 determines whether or not to allocate a bad communication airspace in view of whether or not a flight schedule is a difficult flight schedule (in which the flight path is complex, the flight period is short despite a long flight distance, the weight of a load is large, the luggage is subjected to a large amount of air resistance, etc).

Specifically, when flight airspace allocation unit 102 allocates flight airspace on the basis of the flight schedule of drone 30, if the difficulty level of the flight schedule is lower than a predetermined difficulty level, flight airspace allocation unit 102 determines that the allocation conditions are satisfied, and allocates, as flight airspace, a bad communication airspace in addition to a good communication airspace to that drone 30. In other words, if the difficulty level of a flight schedule is higher than or equal to the predetermined difficulty level, flight airspace allocation unit 102 determines that the allocation conditions are not satisfied, and only allocates a good communication airspace to that drone 30 as flight airspace.

For example, flight airspace allocation unit 102 uses a difficulty level table in which a factor that makes it difficult to achieve a flight according to a flight plan, and the difficulty level of the flight schedule, are associated with each other, to specify the difficulty level of a flight schedule.

FIG. 17 illustrates an example of the difficulty level table. In the example in FIG. 17, the complexity of a flight path is used as a factor that makes it difficult to achieve a flight according to a flight plan, and the complexity is expressed as the number of transit points (the likelihood that the path is complex increases as the number of transit points increases).

The example in FIG. 17 illustrates that, if the number of transit points is no greater than “five”, the difficulty level of a flight schedule is “less than difficulty level threshold Th1”, and if the number of transit points is greater than or equal to “six”, the difficulty level of a flight schedule is “no less than difficulty level threshold Th1”. In the example in FIG. 17, the difficulty level is expressed using a numeric value, and the predetermined difficulty level is expressed using a difficulty level threshold. Flight airspace allocation unit 102 references the difficulty level of the flight schedule associated with, in the difficulty level table, the number of transition points indicated by flight schedule information regarding drone 30, and determines whether or not the difficulty level of the flight schedule indicated by the flight schedule information is less than difficulty level threshold Th1, i.e., whether or not the allocation conditions are satisfied.

FIG. 18 illustrates an example of the difficulty level table using other factors. In FIG. 18(a), the degree of shortness of a flight period is used as a factor that makes it difficult to achieve a flight according to a flight plan, and the degree of shortness is expressed as the ratio of the flight speed (the speed ratio) to the maximum speed (the upper limit of the speed at which drone 30 can fly) when drone flies according to the flight schedule. This is because the fact that drone 30 needs to fly approximately at the maximum speed in order to be in time means that the flight period is not sufficient, and is short relative to the flight distance.

In this difficulty level table, association is established such that, if the speed ratio is less than “70%”, the difficulty level of the flight schedule is “less than difficulty level threshold Th2”, and if the speed ratio is no less than “70%”, the difficulty level of the flight schedule is “no less than difficulty level threshold Th2”. Also, in the example in FIG. 18, the difficulty level is expressed using a numeric value, and the predetermined difficulty level is expressed using a difficulty level threshold. When tentatively determining the allocation of flight airspace, flight airspace allocation unit 102 first allocate flight airspace including a bad communication airspace, and calculates the speed ratio using the flight distance in such a case.

If the calculated speed ratio is associated with “less than difficulty level threshold Th2”, flight airspace allocation unit 102 tentatively determines flight airspace as-is because the allocation conditions are satisfied and a bad communication airspace is to be allocated as well. If the calculated speed ratio is associated with “no less than difficulty level threshold Th2”, flight airspace allocation unit 102 tentatively determines flight airspace as-is if the flight airspace does not include a bad communication airspace, but tentatively determines the allocation of flight airspace excluding a bad communication airspace this time because the allocation conditions are not satisfied and a bad communication airspace is not to be allocated.

In FIG. 18(b), the weight of a load is used as a factor that makes it difficult to achieve a flight according to a flight plan, and the weight is expressed as the ratio of the weight to the maximum loadable weight of drone 30 (the load weight ratio). This is because it becomes more difficult to achieve a flight according to a plan as the load weight ratio increases. In this difficulty level table, association is established such that, if the load ratio is less than “50%”, the difficulty level of the flight schedule is “less than difficulty level threshold Th3”, and if the speed ratio is no less than “50%”, the difficulty level of the flight schedule is “no less than difficulty level threshold Th3”.

In FIG. 18(c), the amount of air resistance is used as a factor that makes it difficult to achieve a flight according to a flight plan, and the amount is expressed as the area of a projection of the front face of the load. In this difficulty level table, association is established such that, if the area of the projection of the front face of the load is “less than E1”, the difficulty level of the flight schedule is “less than difficulty level threshold Th4”, and if the area of the projection of the front face of the load is “no less than E1”, the difficulty level of the flight schedule is “no less than difficulty level threshold Th4”. It is assumed that the weight of the load and the area of the projection of the front face of the load are both indicated by flight schedule information. Therefore, flight airspace allocation unit 102 determines whether or not the allocation conditions are satisfied, in the same manner as in the example in FIG. 17.

Note that the factors that make it difficult to achieve a flight according to a flight plan may be expressed in a different manner. For example, the complexity of a flight path may be expressed as the density of flyable airspace between the departure point and the destination (the complexity of a path is likely to be more complex as the density decreases). Also, the degree of shortness of a flight period may be simply expressed as the ratio between the distance from the departure point to the destination in a straight line and the expected flight time (the time from the estimated departure time to the estimated arrival time). Also, the amount of air resistance is not necessarily expressed as the area of the projection of the front face of the load, but may be expressed as the area of a projection in a side view (the effect of a crosswind makes it difficult for drone 30 to fly).

In any case, factors that make it difficult to achieve a flight according to a flight plan need only be expressed such that the magnitudes of the factors can be compared with each other (e.g., they may be expressed as numerical values). In the present variation, a bad communication airspace is not allocated to drone 30 for which the flight schedule cannot be easily followed. Therefore, this drone 30 always flies in a good communication airspace in a state of being able to communicate with base stations 3. Thus, this drone 30 can receive a flight instruction from server apparatus 10 even if an expected situation occur, and fly in safety compared to when a bad communication airspace is allocated thereto.

In contrast, a bad communication airspace is allocated to drone 30 for which the flight schedule can be easily followed. As a result, it is possible to effectively use the entire airspace compared to a bad communication airspace is not allocated to any drone 30. This drone 30 flies through flight airspace allocated based on an easy flight schedule, and therefore it is possible to increase the safety of drone 30 to which a bad communication airspace is allocated compared to when a bad communication airspace is allocated to all drones 30.

Note that a plurality of factors may be used at the same time. For example, flight airspace allocation unit 102 normalizes values expressing factors (converts the values to values from 0 to 1), and determines that the allocation conditions are satisfied if the sum of values obtained by multiplying the normalized values by predetermined coefficients determined therefor is less than the difficulty level threshold. As a result, it is possible to increase the safety of a flight when there are a combination of a plurality of factors compared to when the allocation conditions are determined using only one factor.

Also, the weight to be given to each factor may be changed by changing the coefficient by which the factor is to be multiplied. For example, if the influence of the weight of a load is the largest among factors that make it difficult to fly according to a flight plan, a weighting coefficient by which the value indicating the weight of the load is to be multiplied is set to be larger than other weighting coefficients. As a result, it is possible to increase the safety of a flight compared to when weighting is not carried out.

### 2-7. Influence of Weather

The flight of drone 30 is susceptive to the weather. For example, if there is an opposing wind, the flight speed decreases and a delay may be caused, and the battery consumption becomes faster and the risk of the battery running out increases. Also, when there is a side wind, it is necessary to apply a propelling force in a direction that is oblique to the travel direction so that drone does not depart from flight airspace, and therefore the battery consumption becomes larger compared to when there is no wind, and the risk of the battery running out increases in this case as well. In the case of rain, the entrance of water may cause a failure.

In addition, if the temperature is too high, the motor is likely to overheat, and if the temperature is too low, the voltage of the battery may decrease to make it impossible for drone 30 to fly. In addition, if it snows, the weight may increase due to snow accumulated on the body of drone 30, and therefore the flight speed will be lower, and the battery consumption will be faster. In this manner, if the weather includes meteorological conditions (rain, wind, snow, high temperature, low temperature, etc.) that may hinder the flight through flight airspace allocated to drone 30, it is likely that an unexpected situation occurs, and the necessity of a flight instruction increases. Therefore, it is preferable that a bad communication airspace is made less likely to be allocated to drone 30.

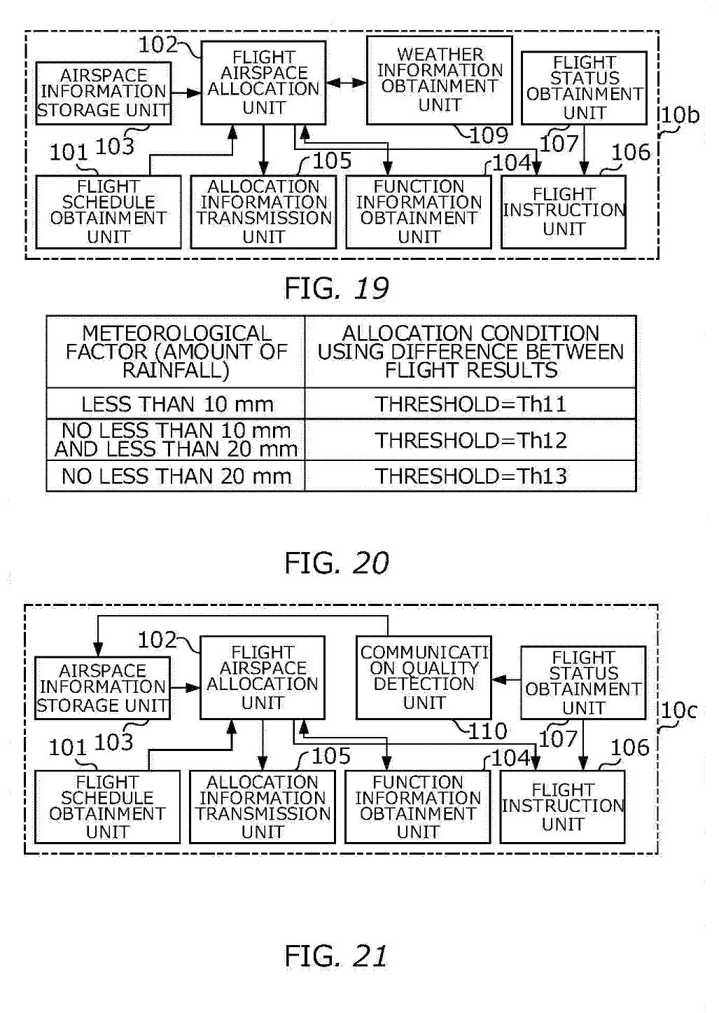

FIG. 19 illustrates a functional configuration realized by server apparatus 10b according to the present variation. Server apparatus 10b includes weather information obtainment unit 109 in addition to the units illustrated in FIG. 4. Weather information obtainment unit 109 obtains information indicating the weather in flyable airspace. Weather information obtainment unit 109 obtains weather information regarding a region including a bad communication airspace indicated by airspace information from weather information (information including the amount of precipitation, a wind direction, a wind force, and the temperature) regarding the current weather, provided via the Internet, for example.

When tentatively determine the allocation of flight airspace, flight airspace allocation unit 102 requests weather information from weather information obtainment unit 109. Weather information obtainment unit 109 obtains the requested weather information, and supplies it to flight airspace allocation unit 102. If the weather in a bad communication airspace includes a meteorological condition (rain, wind, snow, high temperature, low temperature, etc.) that may hinder the flight to be achieved according to a flight plan (a flight through flight airspace allocated to drone 30), flight airspace allocation unit 102 may use an allocation condition that becomes less likely to be satisfied as the degree of hindrance caused by the meteorological condition increases.

For example, when determining whether or not an allocation condition is satisfied based on whether or not the difference between the flight plan and the flight result is no less than the threshold, flight airspace allocation unit 102 uses an allocation condition table in which meteorological conditions and thresholds that are to be used are associated with each other.

FIG. 20 illustrates an example of the allocation condition table. In the example in FIG. 20, allocation conditions using the difference between the flight plan and the flight result, namely “threshold=Th11”, “threshold=Th12”, and “threshold=Th13” (Th11>Th12>Th13) are associated with amounts of precipitation (meteorological conditions), namely “less than 10 mm”, “no less than 10 mm and less than 20 mm”, and “no less than 20 mm”.

In the case of the amount of precipitation, the more the amount of precipitation is, the more a flight is hindered from being pursuant to the flight plan (the same applies to both rain and snow). Therefore, the values of thresholds are set so as to decrease as the amount of precipitation increases, so that it becomes difficult for the allocation conditions to be satisfied. As a result, when the amount of precipitation is large, i.e., when the degree of hindrance to a flight pursuant to a flight plan is high, allocation conditions. are satisfied only by drone 30 for which the difference between the flight plan and the flight result is small, i.e., drone 30 with high capabilities that can stably fly according to the flight.

In addition, in the case of wind, the threshold value is reduced as the wind force increase, and in the case of the temperature, the threshold value is reduced as the difference from the normal temperature increases (as the temperature increases to a high temperature or decreases to a low temperature). Thus, allocation conditions that become less likely to be satisfied as the degree of hindrance caused by the meteorological condition increases are used. In the present variation, the allocation conditions become less likely to be satisfied when the meteorological condition in a bad communication airspace is more likely to hinder a flight from being pursuant to the flight plan, as described above. In such a manner, the more likely a flight instruction is to be required, the less a likely a bad communication airspace is to be allocated. Thus, it is possible to increase the safety of a flight in the allocated flight airspace compared to when a bad communication airspace is allocated without considering meteorological conditions.

Note that in the case where whether or not to allocate a bad communication airspace is determined on the basis of the presence or absence of the avoidance function as in the embodiment, for example, if there are several levels of avoidance functions (e.g. a high level avoidance function and a normal level avoidance function), the present variation is applicable. In this case, if the degree of hindrance caused by a meteorological condition is high, flight airspace allocation unit 102 may limit drones 30 to which a bad communication airspace is to be allocated to drones 30 that have high level avoidance function.

The present variation is also applicable to the case where the allocation distance of a bad communication airspace is limited, as illustrated in FIG. 16. In this case, the number of effective capabilities in the flight distance table illustrated in FIG. 16 may be increased as the degree of hindrance caused by the meteorological condition increases (e.g., although the upper limit of the flight distance in FIG. 16 is set to L1×5 when there is one effective capability, the upper limit may be set to L1×5 when there are two effective capabilities). The present variation is also applicable to the case where the complexity of the flight path is used as described in FIG. 17. In this case, the thresholds shown in FIG. 17 may be increased as the degree of hindrance caused by the meteorological condition increases (because the worse the meteorological condition is, the more likely the time and the distance depart from the plan).

Also, a plurality of meteorological conditions may be used at the same time. For example, flight airspace allocation unit 102 normalizes values expressing the meteorological conditions (the amount of precipitation, the difference between the temperature and the normal temperature, and a wind force) (converts the values to values from 0 to 1), and reduces the above-described thresholds as the sum of values obtained by multiplying the normalized values by predetermined coefficients increases. As a result, it is possible to further increase the safety of a flight compared to when allocation conditions are determined using only one meteorological condition.

In addition, the weight to be given to each meteorological condition may be changed by changing the coefficient by which the meteorological condition is to be multiplied. For example, if the amount of precipitation is the highest degree of hindrance that hinders a flight from being pursuant to a flight plan, the weighting coefficient by which the amount of precipitation is to be multiplied may be set to be greater than other coefficients. As a result, it is possible to increase the safety of a flight compared to when weighting is not performed.

### 2-8. Change in Bad Communication Airspace

A bad communication airspace may change according to the state of the air or the communication status of base stations 3. In the present variation, flight airspace is allocated in view of the change in a bad communication airspace.

FIG. 21 illustrates a functional configuration realized by server apparatus 10c according to the present variation. Server apparatus 10c includes communication quality detection unit 110 in addition to the units illustrated in FIG. 4. Communication quality detection unit 110 detects communication quality in communicable airspace.

In the present variation, flight status obtainment unit 107 obtains a value indicating a communication quality (a reception strength, etc.) from drone 30 as a flight status, and supplies it to communication quality detection unit 110. This drone 30 may be drone 30 that is caused to fly by the business operators, or drone 30 that is caused to fly by the system manager in order to detect the communication quality. Communication quality detection unit 110 determines, on the basis of the position and the value indicated by the supplied flight status, whether or not the communication quality at the position is no lower than a predetermined level.

If the communication quality is no less than the predetermined level, the communication quality detection unit 110 detects the communication quality at the position as being good (i.e., a good communication airspace), and if the communication quality is less than the predetermined level, communication quality detection unit 110 detects the communication quality at the position as being bad (i.e., a bad communication airspace). Communication quality detection unit 110 thus detects a change in a good communication airspace and a change in a bad communication airspace. Communication quality detection unit 110 is an example of a “detection unit” according to the present invention.

Communication quality detection unit 110 supplies the result of detection to airspace information storage unit 103, and airspace information storage unit 103 updates the field of communication quality in airspace information on the basis of the result of detection thus supplied. Flight airspace allocation unit 102 reads out the updated airspace information, and allocates a good communication airspace that reflects the detected change to drone 30 that does not satisfy the allocation conditions. As a result, it is possible to prevent airspace that has changed from a bad communication airspace to a good communication airspace from being allocated to drone 30 that does not satisfy the allocation conditions.

### 2-9. Aircraft

Although the embodiment describes using a rotary wing-type aircraft as an aircraft that carries out autonomous flight, the aircraft is not limited thereto. For example, the aircraft may be a fixed-wing aircraft, or may be a helicopter-type aircraft. Additionally, autonomous flight functionality is not necessary, and for example, a radio-controlled (wirelessly-operated) aircraft, which is operated remotely by an operator, may be used, as long as the aircraft can fly in allocated flight airspace during in allocated permitted flight period.

### 2-10. Apparatuses Implementing Respective Units

The apparatuses implementing the respective functions illustrated in FIG. 4 may be different from those shown in FIG. 4. For example, the functions of server apparatus 10 may be provided in business operator terminals 20 (e.g., business operator terminals 20 dispersed all over the country include airspace information storage unit 103 that stores airspace information regarding the region corresponding thereto). Also, the functions of business operator terminal 20 may be provided in server apparatus 10 (e.g. business operator terminal 20 only displays an input screen and accepts an input operation, and server apparatus 10 includes flight schedule generation unit 201 and generates a flight schedule). Additionally, each function of server apparatus 10 may be realized by two or more apparatuses. In sum, the drone operation management system may include any number of apparatuses as long as the functions of the drone operation management system as a whole are realized.

### 2-11. Category of the Invention

The present invention may be understood as information processing apparatuses, namely the server apparatus and business operator terminal 20, an aircraft, namely drone 30, as well as an information processing system, such as the drone operation management system including those apparatuses and the aircraft. The present invention can also be understood as an information processing method for implementing the processing executed by the respective apparatuses, as well as a program for causing a computer that controls the respective apparatuses to function. The program may be provided by being stored in a recording medium such as an optical disk or the like, or may be provided by being downloaded to a computer over a network such as the Internet and being installed so as to be usable on that computer.

### 2-12. Processing Sequences, etc.

The processing sequences, procedures, flowcharts, and the like of the embodiments described in the specification may be carried out in different orders as long as doing so does not create conflict. For example, the methods described in the specification present the elements of a variety of steps in an exemplary order, and the order is not limited to the specific order presented here.

### 2-13. Handling of Input/Output Information, etc.

Information and the like that has been input/output may be saved in a specific location (e.g., memory), or may be managed using a management table. The information and the like that has been input/output can be overwritten, updated, or added to. Information and the like that has been output may be deleted. Information and the like that has been input may be transmitted to other apparatuses.

### 2-14. Software

Regardless of whether software is referred to as software, firmware, middleware, microcode, hardware description language, or by another name, “software” should be interpreted broadly as meaning commands, command sets, code, code segments, program code, programs, sub programs, software modules, applications, software applications, software packages, routines, subroutines, objects, executable files, execution threads, sequences, functions, and so on.

Additionally, software, commands, and so on may be exchanged over a transmission medium. For example, when software is transmitted from a website, a server, or another remote source using hardwired technologies such as coaxial cable, fiber optic cable, twisted pair cabling, or digital subscriber line (DSL), and/or wireless technologies such as infrared light, radio waves, or microwaves, these hardwired technologies and/or wireless technologies are included in the definition of “transmission medium”.

### 2-15. Information and Signals

The information, signals, and so on described in the specification may be realized using any of a variety of different techniques. For example, data, instructions, commands, information, signals, bits, symbols, chips, and so on that may be referred to throughout all of the foregoing descriptions may be realized by voltages, currents, electromagnetic waves, magnetic fields or magnetic particles, photo fields or photons, or any desired combination thereof.

### 2-16. Systems and Networks

The terms “system” and “network” used in the specification can be used interchangeably.

### 2-17. Meaning of “Based On”

The phrase “based on” used in the specification does not mean “based only on” unless specifically mentioned. In other words, the phrase “based on” means both “based only on” and “based at least on”.

### 2-18. “And” and “Or”

In the specification, with respect to configurations that can be realized both as “A and B” and “A or B”, a configuration described using one of these phrases may be used as a configuration described by the other of these phrases. For example, if the phrase “A and B” is used, “A or B” may be used as long as implementation is possible without conflicting with the other phrase.

### 2-19. Variations, Etc. on Embodiments

The embodiments described in the specification may be used alone, may be combined, or may be switched according to how the invention is to be carried out. Additionally, notifications of predetermined information (e.g., a notification that “X is true”) are not limited to explicit notifications, and may be carried out implicitly (e.g., the notification of the predetermined information is not carried out).

Although the foregoing has described the present invention in detail, it will be clear to one skilled in the art that the present invention is not intended to be limited to the embodiments described in the specification. The present invention may be carried out in modified and altered forms without departing from the essential spirit and scope of the present invention set forth in the appended scope of patent claims. As such, the descriptions in the specification are provided for descriptive purposes only, and are not intended to limit the present invention in any way.

### REFERENCE SIGNS LIST

1 . . . Drone operation management system

10 . . . Server apparatus

20 . . . Business operator terminal

30 . . . Drone

101 . . . Flight schedule obtainment unit

102 . . . Flight airspace allocation unit

103 . . . Airspace information storage unit

104 . . . Function information obtainment unit

105 . . . Allocation information transmission unit

106 . . . Flight instruction unit

107 . . . Flight status obtainment unit

108 . . . Flight results storage unit

109 . . . Weather information obtainment unit

110 . . . Communication quality detection unit

201 . . . Flight schedule generation unit

202 . . . Flight schedule transmission unit

203 . . . Function information storage unit

204 . . . Allocation information obtainment unit

205 . . . Flight control information generation unit

206 . . . Flight control information transmission unit

207 . . . Flight status display unit

208 . . . Flight instruction request unit

301 . . . Flight control information obtainment unit

302 . . . Flight unit

303 . . . Flight control unit

304 . . . Position measurement unit

305 . . . Altitude measurement unit

306 . . . Direction measurement unit

307 . . . Obstacle measurement unit

308 . . . Flight status notification unit

311 . . . Airspace information storage unit

312 . . . Flight path setting unit

313 . . . Other device distance measurement unit

What is claimed is:

1.-10. (canceled)

11. An information processing apparatus comprising:
an allocation unit that allocates flight airspace to aircrafts that fly while communicating with a communication facility, the allocation unit allocating a first airspace, in which the quality of communication with the communication facility is no lower than a predetermined level, to all aircrafts, and allocating a second airspace, in which the quality of communication is lower than the predetermined level, to an aircraft that satisfies a predetermined condition.

12. The information processing apparatus according to claim 11,
wherein the condition is satisfied when a capability of the aircraft is no lower than a predetermined standard.

13. The information processing apparatus according to claim 12,
wherein the allocation unit determines that the capability of the aircraft is no lower than the standard when a difference between a flight plan and a flight result of the aircraft is less than a threshold.

14. The information processing apparatus according to claim 12,
wherein the allocation unit determines that the capability of the aircraft is no lower than the standard when the aircraft has a function of avoiding a collision with an obstacle.

15. The information processing apparatus according to claim 12,
wherein the allocation unit determines that the capability of the aircraft is no lower than the standard when the aircraft has a function of setting a path to a destination.

16. The information processing apparatus according to claim 12,
wherein the allocation unit determines that the capability of the aircraft is no lower than the standard when the aircraft has a function of carrying out a formation flight with another aircraft.

17. The information processing apparatus according to claim 12,
wherein the allocation unit sets an upper limit of a flight distance in the second airspace in flight airspace that is to be allocated to the aircraft that satisfies the condition, to a distance that corresponds to a level of the capability of the aircraft.

18. The information processing apparatus according to claim 11,
wherein the allocation unit allocates the flight airspace based on a flight schedule of the aircraft, and determines that the condition is satisfied when a difficulty level of the flight schedule is lower than a predetermined difficulty level.

19. The information processing apparatus according to claim 11,
wherein, when the weather in the second airspace includes a meteorological condition that hinders the aircraft from flying through the flight airspace allocated thereto, the allocation unit uses, as the condition, a condition that becomes less likely to be satisfied as the degree of hindrance caused by the meteorological condition increases.

20. The information processing apparatus according to claim 11, further comprising:
a detection unit that detects a change in the first airspace,
wherein the allocation unit allocates the first airspace that reflects the detected change, to the aircraft that does not satisfy the condition.
